(19) United States
(12) Patent Application Publication
(10) Pub. No.: US 2026/0092013 A1
(43) Pub. Date: Apr. 2, 2026

(54) PROCESS FOR PREPARING A GREEN MULTILAYER SOL-GEL CERAMIC MEMBRANE

(71) Applicants: PETRÓLEO BRASILEIRO S.A. - PETROBRAS, Rio de Janeiro (BR); UNIVERSIDADE FEDERAL DE MINAS GERAIS - UFMG, Belo Horizonte (BR)

(72) Inventors: DÉBORA GUIMARÃES DA SILVA, Belo Horizonte (BR); PRISCILA CRISTH FONSECA ALVES, Belo Horizonte (BR); WANDER LUIZ VASCONCELOS, Nova Lima (BR); DARLEY CARRIJO DE MELO, Rio de Janeiro (BR); JAILTON FERREIRA DO NASCIMENTO, Rio de Janeiro (BR); DANIELA CORDEIRO LEITE VASCONCELOS, Nova Lima (BR); LEONARDO DOS SANTOS PEREIRA, Rio de Janeiro (BR)

(21) Appl. No.: 19/334,641

(22) Filed: Sep. 19, 2025

(30) Foreign Application Priority Data
Sep. 27, 2024 (BR) 1020240200276

(51) Int. Cl. C04B 35/10; B01D 53/22; B01D 67/00; B01D 69/02; B01D 69/10; B01D 69/12; B01D 71/02; C04B 35/14; C04B 35/624; C04B 35/626; C04B 35/628; C04B 35/64; C04B 38/00

(52) U.S. Cl. CPC C04B 35/10; B01D 67/0046; B01D 67/0048; B01D 69/02; B01D 69/105; B01D 69/108; B01D 69/1218; B01D 71/027; C04B 35/14; C04B 35/624; C04B 35/62655; C04B 35/62807; C04B 35/62813; C04B 35/62886; C04B 35/62894; C04B 35/64; C04B 38/0054; B01D 53/228; B01D 2256/245; B01D 2257/504; B01D 2325/02832; C04B 2235/322; C04B 2235/3418; C04B 2235/6021; C04B 2235/6027; C04B 2235/612

(57) ABSTRACT

The present invention relates to a process for the preparation of a green multilayer sol-gel ceramic membrane for the separation of gaseous CO₂ from natural gas. For being composed solely of ceramic materials (silica and alumina), the ceramic membrane developed by the proposed process has high chemical, physical and mechanical stability as its main characteristics. These characteristics ensure its usefulness in the process of separating CO₂ from natural gas, even in streams having high CO₂ concentrations and under high pressure; the developed membrane further enables backwashing operations to be carried out, when needed.

### FIELD OF THE INVENTION

The present invention is within the field of Oil and Gas, more precisely in the field of oil production processes and primary processing technologies and refers to a process for the preparation of a green multilayer sol-gel ceramic membrane for removal (gaseous separation) of CO₂ from natural gas.

### BACKGROUND OF THE INVENTION

CO₂ removal from natural gas is a critical operation in the oil and gas industry, since CO₂ is the primary contaminant found in natural gas, with concentrations ranging from 5 to 70%, depending on the geographic location (Han Y, Ho W S W. Polymeric membranes for CO2 separation and capture. J Memb Sci 2021; 628:1-24). In Brazil, ANP Ordinance No. 16 of 2008 establishes that in order to be commercialized within the national territory, natural gas must contain less than 3 mol % of CO₂ (ANP, 2008. AGÊNCIA NACIONAL DO PETRÓLEO, GÁS NATURAL E BIOCOMBUSTÍVEIS. Brazil: Resolution ANP No. 16 dated Jun. 17, 2008; 2008). The removal of CO₂ from natural gas is not only a requirement to meet regulatory standards but also improves the quality and energy efficiency of natural gas, reduces the environmental impact associated with CO₂ emissions, and protects the integrity of equipment in the oil and gas industry (ANP, 2020). AGÊNCIA NACIONAL DO PETRÓLEO, GÁS NATURAL E BIOCOMBUSTÍVEIS. Estudo sobre o aproveitamento do gás natural no pré-sal; 2020).

In the past, CO₂ gas separation was performed using various methods across different industrial sectors. The main methods included: chemical absorption in liquids (such as amines, ionic liquids, glycols), adsorption on solid materials (including zeolites, metal oxides, and activated carbon), membrane-based separation (polymeric, zeolitic, hybrid, and contactor membranes), and cryocondensation (Ochedi F O, Yu J, Yu H, Liu Y, Hussain A. Carbon dioxide capture using liquid absorption methods: A review. Environ Chem Lett 2021; 19:77-109; Vega F, Baena-moreno F M, Gallego L M, Portillo E, Navarrete B. Current status of CO2 chemical absorption research applied to CCS: Towards full deployment at industrial scale. Appl Energy 2020; 260:114313; Madejski P, Chmiel K, Subramanian N, Kus T. Methods and techniques for CO2 capture: Review of potential. Energies 2022; 15:887;

Kammerer S, Borho I, Jung J, Schmidt M S. Review: CO2 capturing methods of the last two decades. Int J Environ Sci Technol 2023; 20:8087-104; Lian S, Song C, Liu Q, Duan E, Ren H, Kitamura Y. Recent advances in ionic liquids-based hybrid processes for CO2 capture and utilization. J Environ Sci (China) 2021; 99:281-95; Sanders D F, Smith Z P, Guo R, Robeson L M, McGrath J E, Paul D R, et al. Energy-efficient polymeric gas separation membranes for a sustainablefuture: A review. Polymer (Guildf) 2013; 54:4729-61). Each of the cited techniques has its disadvantages and limitations such as high energy consumption, operating and maintenance costs, chemical or mechanical limitations, difficult scalability, need for complex regeneration or generation of non-recyclable/reusable waste (Ochedi F O, Yu J, Yu H, Liu Y, Hussain A. Carbon dioxide capture using liquid absorption methods: A review. Environ Chem Lett 2021; 19:77-109; Vega F, Baena-moreno F M, Gallego L M, Portillo E, Navarrete B. Current status of CO2 chemical absorption research applied to CCS: Towards full deployment at industrial scale. Appl Energy 2020; 260:114313; Lian S, Song C, Liu Q, Duan E, Ren H, Kitamura Y. Recent advances in ionic liquids-based hybrid processes for CO2 capture and utilization. J Environ Sci (China) 2021; 99:281-95).

Currently, CO₂ removal from natural gas in the oil and gas industry is performed using dense polymeric membranes, such as cellulose acetate, polyimides (PI), polyamides, polysulfone (PSF), polycarbonate (PC) and polyetherimide (PEI) (Han Y, Ho W S W. Polymeric membranes for CO2 separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29). However, natural gas processing plants face serious difficulties when using polymeric membranes, including plasticization effects, fouling, physical aging, long-term stability, short lifespan, high demand for platform space (70%), high energy consumption, and generation of a high volume of non-recyclable or reusable waste (Han Y, Ho W S W. Polymeric membranes for CO₂ separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29; aker R W, Lokhandwala K. Natural gas processing with membranes: An overview. Ind Eng Chem Res 2008; 47:2109-21).

To extend the lifespan of polymeric membranes, it is essential to subject natural gas to pre-treatment processes, such as dehydration and desulfurization, prior to passing it through membranes, hence avoiding the acidic water condensation resulting from the Joule-Thomson effect (Han Y, Ho W S W. Polymeric membranes for CO2 separation and capture. J Memb Sci 2021; 628:1-24; Baker R W, Lokhandwala K. Natural gas processing with membranes: An overview. Ind Eng Chem Res 2008; 47:2109-21). Furthermore, polymeric membranes are subjected to plasticization in the presence of high CO₂ concentrations under elevated pressures, which results in a loss of selectivity (Han Y, Ho W S W. Polymeric membranes for CO2 separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29). According to the literature, polymeric membranes for CO₂ separation tend to undergo plasticization at pressures in the range of 10 to 35 bar and CO₂ concentrations ranging from 30 to 45 cm³(CNTP)/cm³ (Valappil R S K, Ghasem N, Al-Marzouqi M. Current and future trends in polymer membrane based gas separation technology: A comprehensive review. J Ind Eng Chem 2021; 98:103-29). The presence of contaminants such as aromatic compounds and heavy hydrocarbons can also result in plasticization, in addition to causing fouling (clogging) of the polymeric membranes (Valappil R S K, Ghasem N, Al-Marzouqi M. Current and future trends in polymer membrane-based gas separation technology: A comprehensive review. J Ind Eng Chem 2021; 98:103-29; Baker R W, Lokhandwala K. Natural gas processing with membranes: An overview. Ind Eng Chem Res 2008; 47:2109-21). Another challenge is the physical aging of polymeric membranes. The polymers used in these membranes are in a non-equilibrium state and, over time, their polymeric chains tend to relax, preferably to a high-density, low-permeability form, hence reducing the flow of CO₂ across the membrane (Baker R W, Lokhandwala K. Natural gas processing with membranes: An overview. Ind Eng Chem Res 2008; 47:2109-21).

Physical aging, together with the plasticization and encrustation effects caused by the presence of contaminants, high CO₂ concentrations and high feed pressures limit the lifespan of polymeric membranes to no more than 5 years (Chen X, Liu G, Jin W. Natural gas purification by asymmetric membranes: An overview. Green Energy Environ 2021; 6:176-92; Kadirkhan F, Goh P S, Ismail A F, Wan Mustapa W N F, Halim M H M, Soh W K, et al. Recent advances of polymeric membranes in tackling plasticization and aging for practical industrial CO2/CH4 applications—A review. Membranes (Basel) 2022; 12:1-58). Often, after only 3 years of operation, polymeric membranes already show reduced CO₂/CH₄ separation performance of from 20 to 30% (Kadirkhan F, Goh P S, Ismail A F, Wan Mustapa W N F, Halim M H M, Soh W K, et al. Recent advances of polymeric membranes in tackling plasticization and aging for practical industrial CO2/CH4 applications—A review. Membranes (Basel) 2022; 12:1-58), which often results in the need to replace the polymeric membrane modules every 3 years or less. Frequent replacement of polymeric membranes causes serious environmental impacts, such as generation of non-recyclable/reusable waste, environmental contamination, high consumption of natural resources and a larger carbon footprint (Yadav P, Ismail N, Essalhi M, Tysklind M, Athanassiadis D, Tavajohi N. Assessment of the environmental impact of polymeric membrane production. J Memb Sci 2021; 622:118987), in addition to resulting in increased costs with downtime in production process, purchase of new modules and labor required for module replacements.

In addition to the difficulties related to plasticization, fouling, physical aging, long-term stability and short lifespan, another impact when using polymeric membranes for CO₂ removal from natural gas in the oil and gas industry is the increased energy consumption throughout the entire process, due to the need for more efficient pre-treatment of natural gas and high-pressure reinjection of the CO₂-rich stream into the wellbore for secondary recovery of oil and gas.

In Petrobras' current offshore gas processing, natural gas, already separated from oil, enters the gas treatment plant at a pressure of approximately 15 bar. Subsequently, it is passed through a compression step, where pressure is increased to around 55 bar, followed by pre-treatment with desulfurization (in fields having H₂S in the reservoir, dehydration, removal of aromatic compounds and heavy hydrocarbons, in a dew point control unit, before finally going to the polymeric membrane unit for CO₂ removal. The CO2-rich stream (permeate) leaves the polymer membrane unit at a pressure significantly lower than the feed pressure, with permeate pressure values ranging from 2 to 5 bar, depending on the type of polymer membrane used. The permeate stream then needs to be compressed to reach high pressures, typically around 500 bar, before being reinjected into the reservoir for secondary oil and gas recovery. Such compression process for reinjection requires a substantial amount of energy, further increasing the operational costs and contributing to the increased carbon footprint of natural gas production process, since the energy used in the compressors comes from turbogenerators present on the platforms. Undoubtedly, the current operation with polymeric membranes in natural gas processing units is critical with high demand for space in the platform (70%), high consumption of energy and inputs, in addition to generating a high volume of non-recyclable or reusable waste.

In view of the aforementioned challenges with the use of polymeric membranes, there is a need to improve membrane separation technologies for implementation in new platforms, in particular in light of the current projections indicating a 244% increase in Brazil's total natural gas production by 2032 (323 NMm³/day) (EPE, 2022. EMPRESA DE PESQUISA ENERGÉTICA. Estudos do Plano Decenal de Expansão de Energia 2032—Previsão da Produção de Petrõleo e Gás Natural; 2022), compared with the 2022 production (138 NMm³/dia) (ANP, 2022. AGÊNCIA NACIONAL DO PETRÓLEO, GAS NATURAL E BIOCOMBUSTÍVEIS. Encarte de Consolidação da Produção 2022—Boletim da Produção de Petróleo e Gás Natural; 2022). It is estimated that by 2032 a substantial share corresponding to 78% of the total natural gas output (252 Nm³/day) will be sourced from the pre-salt (EPE, 2022. EMPRESA DE PESQUISA ENERGETICA. Estudos do Plano Decenal de Expansão de Energia 2032—Previsão da Produção de Petróleo e Gás Natural; 2022), where the CO₂ concentration may reach 25% (ANP, 2020. AGÊNCIA NACIONAL DO PETRÓLEO, GÁS NATURAL E BIOCOMBUSTÍVEIS. Estudo sobre o aproveitamento do gás natural no pré-sal; 2020). Treatment and reinjection of such a substantial volume of gas using polymeric membranes would result in processing and compression units of unfeasible large sized on the platforms accompanied by extremely high energy consumption. To meet such energy demand, it would be required to increase the energy generation capacity on the platforms to over 100 MW, thereby making the monitoring and control of atmospheric emissions mandatory, as established by CONAMA Resolution No. 382 of 2006 (BRAZIL. CONAMA Resolution no. 372 of Dec. 26, 2006. Establishes the maximum emission limits for atmospheric pollutants from stationary sources; 2006). This, in turn, would result in the need to install pollutant control equipment such as desulfurizers, low-emission burners for nitrogen oxides (NOX) and denitrifiers, which would further increase natural gas production costs and require additional space in the platform.

In summary, the high space requirements on platforms, the significant energy consumption and elevated costs related to equipment, labor and inputs, combined with the environmental impact arising from the generation of large volumes of non-recyclable waste, render the use of polymeric membranes for CO₂ removal from natural gas a limiting solution in the medium to long term.

### STATE OF THE ART

The document issued by COMITE 2017, entitled “PREPARATION OF SILICA MEMBRANES BY SOL-GEL METHOD”, refers to the preparation of silica membranes by the sol-gel method. They also mention that precursors of other ceramic compounds (e.g. Al₂O₃, TiO₂, and so on.) can be introduced during sol-gel synthesis in order to improve some characteristics as well as water stability or stability under hydrothermal conditions.

Firstly, it is important to highlight that the COMITE document itself states that in “sol-gel processing by the polymeric route, the synthesis conditions have a significant impact on the type of silica porosity, and depending on these conditions, mesopores (2 nm<dₚₒᵣₑ<50 nm) or micropores (dₚₒᵣₑ<2 nm) can be obtained”. This is clearly evidenced in the following excerpt from page 13: “The polymeric sol-gel route is chosen when the membrane should be microporous (pore size <2 nm). The synthesis conditions strongly influence the type of accessible porosity of the amorphous silica. The polymeric sol-gel route uses directly the silicon alkoxide Si(OR)₄ as an elemental unit and in principle depending on the synthesis conditions mesopores and/or micropores can be generated.”

The selective layer of the green ceramic membrane of the present invention exhibits a well-defined and strategically engineered pore structure, so that the pore diameter is compatible with the permeation of CO₂ molecules, while being sufficiently small to prevent the passage of molecules of sizes equivalent to or greater than that of CH₄, thus enabling the selective separation of CO₂ from natural gas. This characteristic ensures that the main separation mechanism involved in the selective removal of CO₂ from natural gas is molecular sieving. In other words, molecules with a size equal to or smaller than the pore diameter of the selective layer permeate through the membrane, while larger molecules are retained. The membrane then operates analogously to a sieve with a precisely defined mesh size for the selective separation of particles of a specific size.

Processing of the green ceramic membrane of the present invention has been carefully designed such that, following dip-coating deposition of the silica sol-gel solution and subsequent heat treatment, the pore structure of its selective layer exhibited a very narrow pore size distribution. The center of the pore size distribution is compatible with the CO₂ molecule diameter (kinetic diameter of 0.36 nm), thereby ensuring high efficiency in the selective separation of CO₂ over larger molecules.

Such precise porosity control was achieved by optimizing the synthesis, deposition and heat treatment conditions of the selective layer, as well as of all layers underlying the selective layer, including the ceramic support. Accordingly, the process described in the present invention exhibits unique characteristics for the efficient separation of CO₂ from natural gas, which extend beyond the selective layer to encompass the entire ceramic membrane assembly, including the ceramic support, intermediate layers, separation sub-layer, and final selective layer.

Nevertheless, the present invention relates to a green ceramic membrane having a pore structure and characteristics especially designed for the selective separation of CO₂ from natural gas. In contrast, the COMITE document, while providing a comprehensive literature review on the main properties of silica, sol-gel processing and, more specifically, the preparation of silica membranes using sol-gel methods, does not address the separation of CO₂ from natural gas with the same level of specificity as the present invention. The COMITE document provides a generic and comprehensive approach on silica sol-gel membranes, including information on the separation of gases and liquids in general, but without the specific and detailed focus on the selective separation of CO₂.

Although the COMITE document provides a comprehensive overview of the methodologies and synthesis conditions that affect the formation of silica membranes, it does not disclose a specific protocol for the production of a fully, 100% ceramic membrane, from the support to the final selective layer, intended for the selective separation of CO₂ from natural gas. The COMITE document superficially addresses various techniques for preparing a silica-based selective layer, such as the colloidal and polymeric routes, without providing details on the underlying chemical and thermodynamic principles and their effects on the final structure of the selective layer and performance in the selective separation of CO₂.

Furthermore, the COMITE document discusses the impact of the synthesis conditions on silica porosity in general, without providing the specific details required to replicate the production process. It does not provide sufficient information to allow a person skilled in the art to directly replicate a 100% ceramic membrane that is optimized for the selective separation of CO₂ without first carrying out in-depth research and development, as well as specific and careful experimental tests. While the information provided is valuable for understanding the general principles and variables involved in the sol-gel synthesis of silica membranes, adapting such knowledge to the specific conditions required for the selective separation of CO₂ from natural gas would entail substantial financial investment, considerable effort and several years of research. It would be necessary to optimize process parameters to develop a fully ceramic membrane, from the support to the selective layer, with performance comparable to that of the green ceramic membrane.

Therefore, although the COMITE document is a valuable reference showing the theoretical and technical foundation of sol-gel processing, it does not prevent the patenting of the green ceramic membrane of the present invention, since the present invention presents a detailed and specific synthesis protocol (present invention, notification of invention of the membrane production process), covering from the ceramic support, intermediate layers, separation sub-layer to the final separation layer, intended to obtain a green ceramic membrane with selective CO₂ separation capability from natural gas.

The document to HUSSEIN 2009, “REMOVAL OF CO₂ FROM NATURAL GAS STREAM USING SILICA MEMBRANE”, refers to the removal of CO₂ from a natural gas flow using a silica membrane. More specifically, chapter 3 describes processes of membrane synthesis and mentions the sol-gel process. However, it is found that in the green ceramic membrane of the present invention, the ceramic support is shaped by extrusion to obtain ceramic supports of tubular geometry, whereas in the document by HUSSEIN, the principle used to shape the support is pressing, which results in ceramic supports of flat geometry and circular shape. Although the term “extrusion method” appears in HUSSEIN's document, it was used improperly to make reference to the process of forming the ceramic supports used in the membrane. Upon assessing the detailed description of the adopted methodology, it is evident that the forming method used by the author is pressing. This is clearly demonstrated in the following excerpts on page 22: “pour the powder into a die press and press using handpress at 20 kPa-24 kPa”, “steps 5 to 6 were repeated until we get a perfect alumina disc” e “the alumina discs were sintered at temperature between 1400° C. to 1500° C.”.

Moreover, the green ceramic membrane of the present invention makes use of an acidic catalyst (hydrochloric acid, HCl) in the sol-gel synthesis of the ceramic separation layer of the membrane, whereas in the document by HUSSEIN a basic catalyst is used (ammonium hydroxide, NH₄OH). The type of catalyst (acid or base) used in sol-gel process greatly affects the characteristics of the selective silica layer three-dimensional network, due to differences in TEOS hydrolysis and polycondensation mechanisms. The use of acid catalysts in sol-gel synthesis, such as hydrochloric acid, promotes slower hydrolysis of TEOS ethoxy groups, producing silanols (Si—OH). In an acidic medium, polycondensation begins prior to the end of the hydrolysis step in a controlled and uniform manner. It preferably occurs in end silanols resulting in chain-like structures in the sol and network gels. The polycondensation reaction involves the joining of two silanol groups (Si—OH) to form a siloxane bond (Si—O—Si). After heat treatment, the resulting silica films from sol-gel synthesis using acid catalysts tend to be denser and have smaller pores. When ammonium hydroxide (base) is used as a catalyst, the process follows a basic pH pathway. NH₄OH promotes faster hydrolysis and polycondensation takes place in a less controlled manner, multiple condensation steps result in a structure of small, highly branched clusters, which intertwine to form a colloidal crosslinked gel. After heat treatment, silica films obtained from the sol-gel synthesis using basic catalysts tend to be less dense and have larger pores.

Nevertheless, the document by HUSSEIN mentions aging of the silica sol for 48 hours at room temperature before it is deposited to form the selective layer. The process for producing the green ceramic membrane selective layer of the present invention does not include this step. The green ceramic membrane selective layer is obtained by preparing a silica sol, which, immediately after preparation, is stored at low temperatures (−25° C. to 30° C.) until use. Such silica sol used in the selective layer of the membrane of the present invention, which is prepared at a pH slightly outside the isoelectric point of silica, can be designated as “stock sol”. Preparation of a stock sol ensures that the solution properties remain constant and that reproducible samples are obtained, in addition to optimizing the process for producing the membrane, as it is thus possible to prepare a large volume of solution that can be stored for several months (up to 12 months) without undergoing changes in its physical-chemical properties.

Aging a silica sol-gel solution at room temperature for 48 hours prior to deposition has significant effects on the solution properties and on the final characteristics of the ceramic membranes manufactured therefrom. As the sol-gel solution ages, a continuous progression in the silica polymerization and gelation process occurs. Over time, an aged silica solution tends to increase in viscosity due to the progressive polymerization and gelation. This increase can lead to an irregular and thick deposition, making it difficult to precisely control thickness and obtain a homogeneous layer.

When the silica solution is used without aging, as in the approach adopted in the production process of the green ceramic membrane of the present invention, the silica particles are in a highly dispersed and reactive state, facilitating the formation of a uniform layer during the dip-coating process. Such high reactivity may result in better adhesion of the silica layer to the ceramic supports.

The non-aged silica solution, as used in the approach adopted in the present invention, exhibits very low viscosity, which is also extremely advantageous in terms of controlling the thickness of the layer formed in the dip-coating deposition process. Viscosity of the solution is an important factor for the deposited layer uniformity; solutions with low and controlled viscosity ensure the deposition of a fine and uniform layer, resulting in membranes that impose less restriction to the passage of gas flow. Furthermore, when the solution is not subjected to the aging process, it is less likely to form aggregates or gels that could interfere with uniformity of the layer.

Also, in the protocol presented by the aforementioned document by HUSSEIN, during deposition of the separation layer, the support is immersed in the silica sol and remains immersed for a period of 1 to 3 hours. In contrast, in the production process of the green ceramic membrane of the present invention the ceramic support with intermediate Al₂O₃ layers and SiO₂ sub-layer is removed immediately after immersion in the silica sol. The effective deposition of the silica separation layer takes place as soon as silica sol begins to be removed.

Prolonged immersion of the ceramic support in the silica sol during the dip-coating process can influence multiple aspects of the final properties of the separation layer of a ceramic membrane for gas separation. Although dip coating is an efficient technique for the deposition of thin and uniform films, immersion time is a critical parameter that directly affects thickness, uniformity and porosity of the deposited silica layer.

Prolonged immersion times, such as those described in the HUSSEIN paper, can result in a thicker silica layer due to the longer contact time between the porous support and the solution. Thicker layers increase resistance to gas flow, which usually results in reduced permeance. An additional thickness may be beneficial in certain contexts as it can provide greater mechanical robustness and membrane durability. However, for gas separation applications, an excessive thickness can be detrimental as it reduces the efficiency of separation due to an increased resistance to gas flow across the membrane.

Furthermore, uniformity of the silica layer may be compromised by very long immersion times. During prolonged immersion, particle sedimentation and solvent evaporation in the silica solution can form irregular layers. This may result in an uneven distribution of the film thickness, with some areas being thicker than others. The presence of thicker areas can create spots of varying resistance to gas flow, negatively affecting the membrane selectivity and permeability. Uniformity is crucial to ensure a consistent performance of the membrane in gas separation applications, where defects or thickness variations can prejudice the separation efficacy.

Porosity of the silica layer can also be affected by the immersion time. Prolonged immersion times lead to greater infiltration of the silica sol into the ceramic support pores, filling larger pores and creating a finer and denser pore structure. It can increase the membrane selectivity, as a finer pore structure can better discriminate between different molecular sizes of gases. However, this can also result in a reduced overall permeance, as finer pores offer greater resistance to gas flow. Therefore, the resulting porosity must be carefully balanced to optimize both selectivity and permeability.

In summary, the prolonged immersion time of the ceramic support in the silica sol during dip-coating has a significant impact on the final properties of the ceramic membrane separation layer. While it can increase thickness and potentially the mechanical robustness of the layer, it can also compromise its uniformity and permeance, as well as increase the risk of forming defects. Porosity is also affected, with a possible excessive densification that prejudices the gas flow. Therefore, the immersion time must be carefully controlled and optimized to balance these factors and achieve optimal performance of the membrane in gas separation.

The document by KAHLIB et al., 2017, entitled “SYNTHESIS AND CHARACTERIZATION OF SILICA CERAMIC MEMBRANES VIA SOL-DIP COATING”, refers to the synthesis and characterization of silica ceramic membranes via sol-dip coating, and mentions that the silica ceramic membrane synthesized with good structure and chemical properties has shown great potential for application in biogas separation. However, to achieve the green ceramic membrane of the present invention, an alumina ceramic support in alpha phase is used, which has porosity and mechanical strength designed to be suitable to produce a ceramic membrane having a silica-based selective layer for gas separation. Nevertheless, the ceramic membrane disclosed by KAHLIB et al. uses a commercial ceramic membrane as a ceramic support, which is used in water filtration to obtain drinking water, has chemical composition comprised of aluminum phosphate, as measured by X-ray diffractometry analysis presented by KAHLIB et al.

The green ceramic membrane of the present invention makes use of an acidic catalyst (hydrochloric acid, HCl) in the sol-gel synthesis of the ceramic separation layer of the membrane, whereas in the document by KAHLIB et al. nitric acid (HNO3) is used as a catalyst.

The type of catalyst used in the sol-gel process greatly affects the characteristics of the three-dimensional network of the silica film, due to the differences in TEOS hydrolysis and polycondensation mechanisms. Both acids, HCl and HNO₃, are strong acids and dissociate completely in aqueous solution, providing H⁺ ions that catalyze TEOS hydrolysis and condensation reactions. However, the specific differences between HCl and HNO₃, as their acidity constants (pKa) and the presence of additional ions (Cl⁻ versus NO³—), exert different effects on the stabilization of hydrolysis and condensation reactions. These effects are even more pronounced when these acids are used at different concentrations (information not provided by KAHLIB et al.) in sol-gel processing.

By affecting the polymerization process in the sol-gel, the exchange of HCl for HNO₃ also results in differences in the final microstructure of the silica gel. While they both lead to the random formation of branched or linear chains in silica solutions, the presence of nitrate ions (NO3-) in HNO₃-catalyzed solutions causes variations in the charge distribution and in the silica network structure formed in relation to HCl-catalyzed solutions. This difference leads to the formation of a more open and porous silica structure when compared to the structure formed in the presence of HCl. These changes in the silica structure can directly affect the material application and efficacy, in particular in contexts that require the porosity and density of the silica network to be precise controlled, such as in gas separation membranes.

Moreover, the silica solution used in the preparation of the selective layer of the green ceramic membrane of the present invention is subjected to a silica sol filtration step just prior to deposition. Such filtration step is not reported in the membrane producing process disclosed by KAHLIB et al.

Filtration of silica sol prior to deposition is a critical step to improve both quality and performance of ceramic membranes for gas separation. Filtering the sol through a 0.22 m filter removes larger particles and agglomerates, resulting in a more homogeneous solution and, accordingly, a uniform, defect-free layer, which increases the membrane selectivity and permeability. Filtration, as performed in the approach adopted in the process for the production of the green ceramic membrane of the present invention, prevents cracks and irregularly sized pores that could compromise the membrane integrity from forming, ensuring a well-controlled porosity and better efficiency in gas separation. Moreover, filtration contributes to stability of the sol by preventing the sedimentation of larger particles and ensuring a stable and consistent solution for deposition processes such as dip-coating, resulting in reproducible high-quality layers.

Also, the document by KAHLIB et al. describes the deposition of a highly concentrated silica sol having a TEOS:H₂O:C₂H₅OH molar ratio of 1:4.7:3.8, to obtain the ceramic membrane selective layer. However, the green ceramic membrane selective layer of the present invention, despite being produced using a silica sol with molar ratios similar to those in the document by KAHLIB et al., dilutes the silica sol 18 times in volume prior to deposition of the selective silica layer.

When a silica sol is deposited via dip coating without further dilution, the resulting silica layer tends to be too thick. This increased thickness may eventually be beneficial in terms of mechanical strength of the membrane. However, thicker layers also pose significant challenges, including the formation of defects and cracks during drying and heat treatment processes, due to the internal stresses that build up, in particular when successive depositions are performed. In terms of porosity, the silica layer formed by an undiluted sol tends to have a more closed and denser pore structure, even before heat treatment.

Diluting the silica sol prior to deposition, as in the approach adopted in the present invention, causes a significant reduction in the solution viscosity, resulting in a considerably thinner final layer. Thinner layers are less prone to cracks and defects, which improves membrane uniformity and integrity. The application of multiple thin layers (three or more depositions), as in the approach adopted in the present invention, helps to build a more homogeneous and uniform structure, minimizing weak spots and defects in the selective layer. Furthermore, the sol dilution, as carried out in the approach adopted in the present invention, also affects the pore structure of the formed layer, leading to the formation of a more open and porous three-dimensional network.

After heat treatment, both layers (with no dilution and with an 18-fold dilution) are subjected to densification process, where the siloxane (Si—O—Si) bonds are reinforced, resulting in a more stable and durable structure. The undiluted layer, due to its greater thickness, tends to present greater densification, which increases the issues of cracks and defects if not carefully treated. On the other hand, the diluted layer, as performed in the approach adopted in the present invention, with its more porous and open structure, experiences less stress during densification, resulting in a more uniform and defect-free final layer.

Nevertheless, the selective layer deposition protocol via dip-coating presented by the document by KAHLIB et al. does not provide sufficient information to characterize the selective layer as having the same characteristics as the selective layer of the green ceramic membrane of the present invention. Deposition of silica sol-gel selective layers via dip-coating is a widely used technique to produce ceramic membranes for the selective separation of CO₂. However, the characteristics and performance of the formed layer change significantly depending on the deposition conditions. In the deposition of a silica sol via dip-coating, the immersion time and withdrawal speed must be carefully controlled, as they are essential to ensure the uniformity and reproducibility of the selective layer. Such control is essential for the formation of a homogeneous layer, with no defects and having a pore structure suitable for the selective separation of CO₂.

The specific dip-coating deposition conditions are not provided in the document by KAHLIB et al. The only information available is that the layer was deposited using dip-coating, with no details on the immersion time or withdrawal speed. Without such detailed information, it cannot be stated that the selective layer was deposited with the same level of control as in the present invention. Uncontrolled immersion and removal can result in an irregular layer with significant variations in thickness and pore distribution. This can lead to the formation of defects, such as cracks and areas of variable thickness, which affect the membrane selectivity and permeability. Therefore, the lack of information on the control parameters of the dip-coating deposition prevents an adequate comparison between the two selective layers. Structural differences, such as porosity and layer uniformity, cannot be attributed solely to the dip-coating method if the deposition conditions are unknown and not comparable.

The document to KAMARUDIN, 2010, entitled “CO₂ REMOVAL BY USING SILICA BASED MEMBRANE”, refers to the removal of CO₂ using a silica membrane. More specifically, chapters 2 and 3 describe processes for the synthesis of membranes and mention the sol-gel process.

However, chapter 2 of KAMARUDIN document presents a brief literature review on the theoretical foundations involving membranes for CO₂ separation, including gas separation mechanisms, membrane classifications according to the porosity degree, membrane classification according to their pore structure and chemical composition.

Specifically concerning ceramic membranes for gas separation (p. 11), the bibliographic review presents generic comments on ceramic membranes with a selective silica layer for gas separation. KAMARUDIN mentions that, due to the absence of sufficient mechanical strength, the selective silica layer is deposited on a macroporous ceramic support and it is not uncommon for intermediate layers to be deposited between the support and the selective layer. Although the literature review mentions the existence of intermediate layers between the ceramic support and the selective layer, specific details about the production process, the pore structure and the chemical composition of these layers are not presented.

Regarding the sol-gel method (p. 12), the bibliographic review presented is restricted to only a few comments about ceramic membranes having a selective silica layer obtained from the deposition of a colloidal particle suspension (methodology adopted in KAMARUDIN) and a silica polymer chain solution (methodology described in the present invention). No information is presented on important sol-gel processing parameters for the polymeric pathway to properly control the pore structure of the silica layer, such as type and purity of reagents, molar ratio of reagents, synthesis time and temperature, pH and concentration of the final solution, among others.

It is important to note that, although the document by KAMARUDIN mentions the use of the dip-coating technique for selective layer deposition in Chapter 3 (methodology), in Chapter 2 it refers to the slip-casting technique for depositing colloidal sols on porous supports. As discussed in detail below (item iii), the nature of the silica solution disclosed in KAMARUDIN document leaves doubt about the main mechanism involved in the deposition of the selective layer of the KAMARUDIN document.

Also, it is found that in the green ceramic membrane of the present invention, the ceramic support is shaped by extrusion to obtain ceramic supports of tubular geometry, whereas in the document by KAMARUDIN, the principle used to shape the support is pressing, which results in ceramic supports of flat geometry and circular shape.

Although the term “extrusion method” appears in KAMARUDIN document, it was used improperly to make reference to the process of forming the ceramic supports used in the membrane. Upon assessing the detailed description of the adopted methodology, it is evident that the forming method used by the author is pressing. This is clearly demonstrated in the following excerpts on page 15: “the powder is poured in the die press and pressed it using hand press at the pressure of 6 tonnes”, “steps 4 to 7 are repeated until we get a perfect alumina discs” e “the alumina discs were sintered at temperature 1300° C.”.

Furthermore, the H₂O:TEOS molar ratio described in the methodology presented in the KAMARUDIN document (118:1) is much higher than the stoichiometric molar ratio (4:1) for hydrolysis and polycondensation of tetraethylorthosilicate; therefore, in the KAMARUDIN document a selective layer was obtained from a suspension of colloidal silica particles synthesized via sol-gel processing, rather than a selective layer obtained from a three-dimensional silica structure as in the production process adopted in the green ceramic membrane of the present invention.

When a sol-gel synthesis is carried out in an acidic medium using a H₂O:TEOS molar ratio close to the stoichiometric ratio (4:1), the hydrolysis and condensation reactions proceed in a controlled manner, with hydrolysis of the TEOS ethoxy groups occurring first, followed by the condensation step that begins before the hydrolysis is fully complete. This results in the formation of a three-dimensional silica network with chain-like structures. Such network is characterized by a highly interconnected structure, where silica molecules connect to each other forming a continuous structure after gelatinization (sol-gel transition). After heat treatment, such three-dimensional silica network densifies, resulting in materials with high thermal and mechanical stability. When the solution is deposited as a film for the manufacture of gas separation membranes, the three-dimensional network formed tends to have small and uniformly distributed pores, creating an effective barrier for the separation of gas molecules based on size and shape.

When a sol-gel synthesis carried out in an acidic medium uses a H₂O:TEOS molar ratio significantly higher than the stoichiometric ratio, as in the case of the KAMARUDIN document where the ratio is 118:1, the hydrolysis reactions occur much more rapidly because the acid catalyst promotes TEOS protonation and the excess water in turn accelerates the hydrolysis reaction due to the abundance of water molecules available to react with TEOS. Since an acid catalyst is used, the condensation rate is also initially rapid, but in an excess water environment, formation of siloxane bonds is hindered by dilution of the reactive species (silanols). Excess water makes condensation less efficient, making it difficult to form a three-dimensional silica network, which is essential for a solid, interconnected structure. The silica colloidal particles formed in excess water are small and highly dispersed, resulting in a stable colloidal suspension. The ceramic film obtained by depositing a suspension of colloidal particles on a surface is fragile and has a more open pore structure. Performing heat treatment can promote further condensation of silica colloidal particles, leading to the formation of stronger and more stable siloxane (Si—O—Si) bonds and a more closed structure.

Nevertheless, the green ceramic membrane of the present invention makes use of an acidic catalyst (hydrochloric acid, HCl) in the sol-gel synthesis of the membrane ceramic separation layer, whereas in the document by KAMARUDIN nitric acid (HNO₃) is used as a catalyst.

The type of catalyst used in the sol-gel process greatly affects the characteristics of the three-dimensional network of the silica film, due to the differences in TEOS hydrolysis and polycondensation mechanisms. As previously discussed, (item iii), the high water molar ratio used in the sol-gel processing adopted by KAMARUDIN for the synthesis of the selective silica layer per se already characterizes that the structure of the material developed by KAMARUDIN differs from the structure presented by the green ceramic membrane of the present invention.

However, it is worth making some important comments on the effect on the kinetics of the hydrolysis and condensation reactions and also on the silica structure formed when different acid catalysts are used in sol-gel processing.

Both acids, HCl and HNO₃, are strong acids and dissociate completely in aqueous solution, providing H⁺ ions that catalyze TEOS hydrolysis and condensation reactions. However, the specific differences between HCl and HNO₃, as their acidity constants (pKa) and the presence of additional ions (Cl⁻ versus NO₃—), exert different effects on the stabilization of hydrolysis and condensation reactions. These effects are even more evident when these acids are used in different concentrations in sol-gel processing.

By affecting the polymerization process in the sol-gel, the exchange of HCl for HNO₃ also results in differences in the final microstructure of the silica gel. While they both lead to the random formation of branched or linear chains in silica solutions, the presence of nitrate ions (NO3-) in HNO₃-catalyzed solutions causes variations in the charge distribution and in the silica network structure formed in relation to HCl-catalyzed solutions. This difference leads to the formation of a more open and porous silica structure when compared to the structure formed in the presence of HCl. These changes in the silica structure can significantly affect the material application and efficacy, in particular in contexts that require the porosity and density of the silica network to be precise controlled, such as in gas separation membranes.

Moreover, the document by KAMARUDIN mentions aging of the silica sol for 48 hours at room temperature before it is deposited to form the selective layer. The process for producing the green ceramic membrane selective layer of the present invention does not include this step. The green ceramic membrane selective layer of the present invention is obtained by preparing a silica sol, which, immediately after preparation, is stored at low temperatures (−25° C. to 30° C.) until use. Such silica sol used in the selective layer of the membrane of the present invention, which is prepared at a pH slightly outside the isoelectric point of silica, can be designated as “stock sol”. Preparation of a stock sol ensures that the solution properties remain constant and that reproducible samples are obtained, in addition to optimizing the process for producing the membrane, as it is thus possible to prepare a large volume of solution that can be stored for several months (up to 12 months) without undergoing changes in its physical-chemical properties.

The silica solution used to prepare the selective layer of the green ceramic membrane of the present invention is subjected to a silica sol filtration step immediately prior to its deposition. Such a filtration step is not reported in the membrane producing process disclosed by KAMARUDIN.

Filtration of the silica sol prior to deposition, as performed in the approach adopted in the production process of the green ceramic membrane of the present invention, is a critical step to enhance the quality and performance of ceramic membranes for gas separation. Filtering the sol through a 0.22 μm filter removes larger particles and agglomerates, resulting in a more homogeneous solution and, accordingly, a uniform, defect-free layer, which increases the membrane selectivity and permeability. Filtration prevents the formation of cracks and irregularly sized pores that could harm the membrane integrity, ensuring well-controlled porosity and better efficiency in gas separation. Moreover, filtration contributes to stability of the sol by preventing the sedimentation of larger particles and ensuring a stable and consistent solution for deposition processes such as dip-coating, resulting in reproducible high-quality layers.

In the protocol presented by the document by KAMARUDIN, during deposition of the separation layer, the support is immersed in the silica sol and remains immersed for a period of 1 to 3 hours. In contrast, in the production process of the green ceramic membrane of the present invention the ceramic support with intermediate Al₂O₃ layers and SiO₂ sub-layer is removed immediately after immersion in the silica sol. The actual deposition of the silica separation layer takes place as soon as the removal of silica sol begins.

Prolonged immersion of the ceramic support in the silica sol during the dip-coating process significantly affects the properties of the separation layer in ceramic membranes for gas separation. The duration of immersion directly influences the thickness, uniformity, and porosity of the silica layer. Prolonged immersion can lead to thicker layers, which increase resistance to gas flow, hence reducing permeance. Layer uniformity may also be compromised due to thickness variations across the membrane, adversely affecting both selectivity and permeability. Porosity is also affected. Long immersions tend to form a finer and denser pore structure, which can enhance selectivity but reduce permeance. Therefore, immersion times must be carefully controlled to optimize thickness, uniformity and porosity, thereby balancing membrane selectivity and permeability.

The document by KAJAMA et al., 2018, entitled “SILICA MODIFIED MEMBRANE FOR CARBON DIOXIDE SEPARATION FROM NATURAL GAS,” refers to a silica-modified membrane for separation of carbon dioxide from natural gas, and mentions that the dip-coating technique was used to prepare the membrane from a commercial ceramic support.

Meanwhile, in the green ceramic membrane of the present invention, the method used for synthesizing the solution that forms the selective layer of the ceramic membrane is sol-gel processing. Unlike the present invention, in the document by KAJAMA et al., the process of obtaining the selective layer involves the formation of a silicone-based matrix via polymerization reaction and subsequent curing of the silicone elastomer, and such method can be designated as “polymerization and curing method”.

In the document by KAJAMA et al. a silicone elastomer (Sylgard) is mixed with isopentane and a curing agent (Sylgard) to form a mixture that is subsequently deposited on a ceramic support to form the separation membrane. The isopentane used serves as a solvent to dilute the elastomer and facilitate the even application of the coating over the ceramic support. Heat treatment following deposition facilitates the curing of the silicone elastomer, converting the liquid solution into a solid, adherent silicone film on the support. This method is different from sol-gel processing (present invention), which is used to form ceramic or glass films (such as silica) from molecular precursors in solution. In the case described in the document by KAJAMA et al., the method used is specific for the formation of a silicone elastomer film.

Furthermore, the chemical composition of the ceramic membrane selective layer for gas separation that is the object of the present invention is silica (SiO₂). In contrast, in the document by KAJAMA et al. the selective layer comprises a silicone polymer (polydimethylsiloxane).

Polydimethylsiloxane (PDMS), which is the main component of silicone elastomer Sylgard, is a siloxane polymer comprised of repeating dimethylsiloxane units. Upon addition of the curing agent, typically a platinum catalyst, hydrosilylation reactions promote the cross-linking of PDMS chains, transforming the liquid solution into a solid material. Isopentane is used as a solvent to dilute the silicone elastomer, facilitating an even application of the coating, while not participating in the chemical reactions that form the PDMS crosslink. During the curing process, isopentane evaporates, leaving the PDMS matrix cross-linked. Presence of the platinum catalyst is minimal and only residual after curing, not contributing significantly to the chemical composition of the end material. Thus, after curing, the final chemical composition of the selective layer is predominantly polydimethylsiloxane (PDMS) with a three-dimensional network of intertwined silicone chains due to the action of the curing agent. The simplified chemical structure of cross-linked PDMS can be represented by the chemical formula shown in equation 1.

[Si(CH₃)₂—O]— (1)

Furthermore, the precursor solution of the green ceramic membrane selective layer of the present invention has distinct nature and characteristics than the solution used to achieve the selective layer in the document by KAJAMA et al. This difference results in significant variations in the control parameters and their impact on the final structure of the selective layer during the dip-coating deposition process.

Although the term “dip-coating” is a generic designation for coating deposition techniques where a substrate is immersed in a solution, it is imperative to understand that the specific application of this technique can vary considerably depending on the nature of the solutions used. In the instance of ceramic membranes for selective separation of CO₂ of the present invention and document KAJAMA et al., the solutions used in deposition of the selective layer are fundamentally different, which implies significant variations in the control parameters and in the final coating results.

The selective layer of the membrane of the present invention is produced from a silica sol obtained by sol-gel processing, which is diluted 18 times in volume with anhydrous ethanol prior to deposition, resulting in a low viscosity solution. The control parameters adopted in dip-coating, such as immersion time and withdrawal speed, are carefully adjusted to ensure a uniform, defect-free layer. These control parameters are also essential in adjusting the thickness and porosity of the selective layer, directly affecting the membrane selectivity and permeance.

In contrast, in the document by KAJAMA et al., the selective layer is obtained from a solution containing a mixture of silicone elastomer (Sylgard) with isopentane and a curing agent (Sylgard). This solution exhibits a significantly different viscosity and requires different control parameters during dip-coating. The immersion time and withdrawal speed must be adjusted to accommodate the higher viscosity and the subsequent cross-linking of the silicone elastomer chains during the curing step that converts the liquid solution into a solid material.

Therefore, the fact that both documents use dip-coating for the deposition of its selective layers does not imply that the technique is the same. Different solutions require specific adjustments to the control parameters and result in layers with distinct structural characteristics. The nature of the materials used, the dilution requirements, viscosity of the solutions and the thermal curing conditions are factors that significantly distinguish the processes.

It is important to emphasize that the existence of bibliographic references reciting the use of dip-coating for the deposition of a selective layer in membranes for CO₂ selective separation does not invalidate the patent application for a membrane that also employs dip-coating to deposit a selective layer. Differences in materials and processing parameters result in distinct products with unique properties and functionalities. Thus, the dip-coating technique, when applied in a manner adapted to the specific characteristics of each solution, justifies the innovation and originality of the selective layer deposition process on each membrane, thereby enabling intellectual property protection.

### BRIEF DESCRIPTION OF THE INVENTION

The present invention is intended to provide a process for the preparation of a green multilayer sol-gel ceramic membrane for the removal (gaseous separation) of CO₂ from natural gas (CO₂/N₂ or CO₂/CH₄) comprising the following steps:
a) production of a tubular-shaped porous ceramic support of chemical composition α-Al₂O₃ (1), via extrusion of ceramic slurry followed by heat treatment under ambient atmosphere and atmospheric pressure;
b) preparation and deposition of the first intermediate ceramic layer of chemical composition α-Al₂O₃ (2) via slip casting deposition of suspension of submicrometric ceramic particles of α-Al₂O₃ followed by heat treatment under ambient atmosphere and atmospheric pressure;
c) preparation and deposition of the second intermediate ceramic layer with chemical composition γ-AlOOH (3), via slip casting deposition of a nanometric ceramic particle suspension of γ-AlOOH synthesized via the sol-gel pathway, followed by heat treatment under ambient atmosphere and atmospheric pressure;
d) synthesis and deposition of the ceramic separation sub-layer of the green ceramic membrane, the third mesoporous SiO₂ layer (4), via immersion deposition in a solution of silica polymer chain nanoparticles synthesized via the sol-gel pathway, followed by heat treatment under ambient atmosphere and atmospheric pressure; and
e) synthesis and deposition of the ceramic separation layer of the green ceramic membrane, the fourth microporous SiO₂ layer (5), via immersion deposition in a solution of silica polymer chains synthesized via the sol-gel pathway, followed by heat treatment under ambient atmosphere and atmospheric pressure.

### BRIEF DESCRIPTION OF THE FIGURES

FIG. 1 presents an overall flowchart of the process for the preparation of a green, multilayer sol-gel ceramic membrane for removal, as proposed in the present invention.

FIG. 2 shows the detailed flowchart of step a) of the process for preparing a green, multilayer sol-gel ceramic membrane for removal, as proposed in the present invention, with the production of the ceramic support.

FIG. 3 shows the detailed flowchart of step b) of the process for preparing a green, multilayer sol-gel ceramic membrane for removal, as proposed in the present invention, with the deposition of the first α-Al₂O₃ intermediate layer.

FIG. 4 shows the detailed flowchart of step c) of the process for preparing a green, multilayer sol-gel ceramic membrane for removal, as proposed in the present invention, with deposition of the second γ-Al₂O₃ intermediate layer.

FIG. 5 shows the detailed flowchart of step d) of the process for preparing a green, multilayer sol-gel ceramic membrane for removal, as proposed in the present invention, with deposition of the mesoporous silica separation sub-layer.

FIG. 6 shows the detailed flowchart of step e) of the process for preparing a green, multilayer sol-gel ceramic membrane for removal, as proposed in the present invention, with deposition of the microporous silica ceramic selective layer.

### DETAILED DESCRIPTION OF THE INVENTION

The present invention relates to a process for the preparation of a green, multilayer sol-gel ceramic membrane for removing (gaseous separation) CO₂ from natural gas (CO₂/N₂ or CO2/CH₄) comprising the following steps:
a) production of a tubular-shaped porous ceramic support of chemical composition α-Al₂O₃ (1), with an average pore size ranging from 0.7 to 0.9 μm. Processing via extrusion of ceramic slurry followed by heat treatment under ambient atmosphere and atmospheric pressure;
b) preparation and deposition of the first intermediate ceramic layer of chemical composition α-Al₂O₃ (2) and an average pore size of from 80 to 100 nm. Processing via slip casting deposition of a suspension of submicrometric ceramic particles of α-Al₂O₃ followed by heat treatment under ambient atmosphere and atmospheric pressure.
c) Preparation and deposition of the second intermediate ceramic layer of chemical composition γ-Al₂O₃ (3) and an average pore size of from 4 to 20 nm. Processing via slip casting deposition of a nanometric ceramic particle suspension of γ-AlOOH synthesized via the sol-gel pathway followed by heat treatment under ambient atmosphere and atmospheric pressure.
d) Synthesis and deposition of the ceramic separation sub-layer of the green ceramic membrane, the third mesoporous SiO₂ layer (4) with an average pore size of 2 nm. Processing via immersion deposition in a solution containing silica polymer chain nanoparticles synthesized via the sol-gel pathway, followed by heat treatment under ambient atmosphere and atmospheric pressure.
e) Synthesis and deposition of the ceramic separation layer of the green ceramic membrane, the fourth microporous SiO₂ layer (5), with an average pore size of less than 0.4 nm. Processing via immersion deposition in a solution containing silica polymer chains synthesized via the sol-gel pathway, followed by heat treatment under ambient atmosphere and atmospheric pressure.

After the four ceramic layers have been deposited on the ceramic support, the green ceramic membrane is finished and ready for performing selective gas separation (6) of CO₂ from CH₄ or N₂.

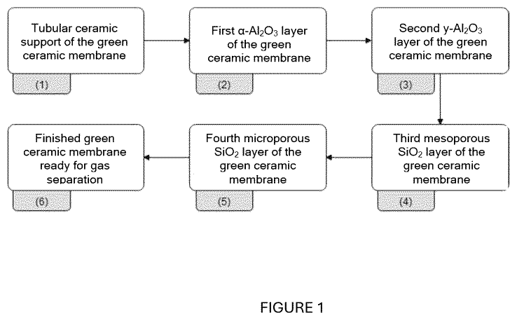

The proposed process, as seen in the flowchart presented in FIG. 1, can be classified as an environmentally friendly and sustainable process for several reasons. One of them is that the manufacturing steps of both the ceramic support and the subsequent ceramic layers of the membrane are performed using low-complexity equipment, under ambient atmosphere and atmospheric pressure, without the need for special conditions. This results in savings of energy and resources that would be otherwise required in processes performed under more stringent conditions. The use of advanced technologies and specific equipment for each stage of the process reflects a commitment to efficiency and the minimization of wasted resources. Production under controlled environments, such as laminar flow hoods and climate-controlled chambers, ensures the quality of the final products and minimizes any environmental contamination.

Regarding the reagents and equipment used, it is important to note that the process uses materials commonly found in laboratories and industries, which facilitates the availability and proper management of chemicals. The selection of appropriate reagents and solvents along with the recovery of spent acids contributes to the reduction of chemical waste and the minimization of environmental impact. Furthermore, the use of ceramics as the primary material for both the support and membrane layers is relevant from a sustainability standpoint. Ceramics are known for their durability and resistance to adverse conditions, which increases the membrane lifespan. This results in less waste disposal and less need to replace membranes, reducing the environmental impact.

In summary, the proposed process is classified as green and environmentally friendly, as it aligns with environmental goals such as climate change mitigation, the use of durable materials, the optimization of resources, careful selection of reagents and the adoption of high-efficiency equipment. It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

The steps will be described in more detail below. It should be noted that the reagents and equipment are provided merely as illustrative examples for the implementation of the invention and are not intended to be limiting.

a) Production of a Tubular-Shaped Porous Ceramic Support of Chemical Composition α-Al₂O₃

The following reagents and equipment are used to obtain the ceramic support for the green ceramic membrane (1):

### Reagents:

aluminum oxide in the alpha crystalline phase;
27.5-31.5% Methylcellulose (DuPont, Methocel A4M);
deionized water; and
glycerol.

### Equipment:

semi-analytical scale (Marte, UX8200S);
water purifier (Merk, DirectQ 5 UV);
intensive mixer (Eirich, RV02E);
extruder (ECT, VALR 50B);
climate-controlled chamber with temperature and humidity control (Solid Steel, SL-206);
drying oven with air circulation (Nabertherm, TR-120);
sintering furnace (Termolab, MLR 06/98);
cutter (Buheler, Isomet); and
ultrasonic bath (Elmasonic, P300H).

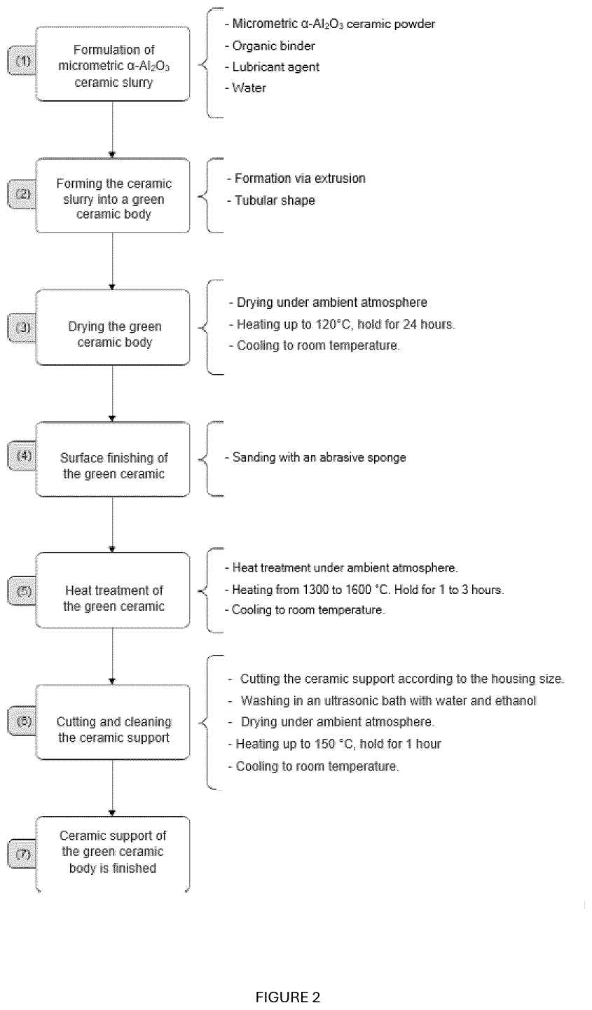

FIG. 2 shows the detailed flowchart of the first stage of the production process of the green ceramic membrane (GCM), which corresponds to the process of obtaining the green ceramic support. The ceramic support is responsible for providing sufficient mechanical strength to the assembly, enabling application of the green ceramic membrane in the gas separation process.

The ceramic support is achieved via tubular extrusion of a ceramic slurry. The ceramic slurry (1) is prepared in an intensive mixer and is composed of micrometric alumina particles (2 to 10 μm) in the alpha crystalline phase (α-Al₂O₃), at least one organic binder (methyl cellulose, polyethylene glycol, carboxymethyl cellulose, polyvinyl alcohol, or others), at least one lubricant agent (glycerol, olein, graphite, or others) and deionized water. Sintering agents can also be added to the ceramic slurry to facilitate atomic diffusion, promote material densification during sintering, and reduce the temperature required to reach the dense phase. Sintering agents that can be used include metal oxides such as magnesium oxide, titanium oxide or zirconium oxide.

The ceramic slurry is then formed into a tubular-shaped green ceramic body (2), typically having an outer diameter of 10.5 mm and an inner diameter of 7.5 mm in an extruder. Another possible process for forming ceramic supports is via pressing, where flat ceramic supports can be obtained. After forming, the green ceramic body is subjected to a drying step (3) with a stepwise reduction of the moisture content under ambient atmosphere, by drying at temperatures of up to 120° C., holding the temperature for up to 24 hours, followed by cooling to room temperature. After drying, the green ceramic body acquires sufficient mechanical strength for handling, allowing polishing of the deposition surface (4) of the separation layers using abrasive sponges of varying grit sizes (P320 to P1500) until a smooth and defect-free surface is achieved.

Next, the green ceramic body is subjected to a heat treatment step (5) where, through sintering of the alumina particles, it will acquire sufficient mechanical strength to be used as a ceramic support for the green ceramic gas separation membranes. Sintering of the green ceramic body is carried out under ambient atmosphere at temperatures ranging from 1300° C. to 1600° C., according to the desired porosity and mechanical strength. The dwell time at the hold period at the sintering temperature can also range from 1 to 3 hours depending on the desired final characteristics.

After sintering, the green ceramic support is subjected to a cutting step according to the housing size and cleaning (6) for deposition of the green ceramic membrane layers. Cleaning can be performed in an ultrasonic bath using water and ethanol followed by drying the ceramic support under ambient atmosphere at 120-150° C. After cleaning, preparation of the green ceramic support is finished (7) and it is ready to proceed to the second stage of the process for producing the green ceramic membrane for CO₂/N₂ and CO₂/CH₄ gas separation, with deposition of the first intermediate green ceramic layer of α-Al₂O₃.

All materials used in the preparation of the ceramic support are non-toxic and do not harm the environment, characterizing the process of obtaining the ceramic support as environmentally friendly and the ceramic support as a green ceramic support. The ceramic support is obtained from abundantly available raw materials such as alumina, and the process is designed to minimize waste of material and energy. These practices, along with the choice of more sustainable materials and production methods, make the process of producing the green tubular ceramic support an environmentally friendly option that contributes to reducing the environmental impact in the industry of ceramic membranes for gas separation.

It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

b) Preparation and Deposition of the First Intermediate Ceramic Laver of Chemical Composition α-Al₂O₃

The following reagents and equipment are used to obtain the first intermediate ceramic layer of the green ceramic membrane (2):

### Reagents:

aluminum oxide in the alpha crystalline phase;
deionized water;
polyvinyl alcohol PVA 35% (Zschimmer and Schuwarz, PAF 35);
carboxymethyl cellulose CMC 90% (Zschimmer and Schuwarz, Optapix C12G); and
carboxylic acid 65% (Zschimmer and Schuwarz, Dolapix CE64).

### Equipment:

analytical scale (Shimadzu, AUX-320);
water purifier (Merk, DirectQ 5 UV);
magnetic stirrer (Ika, C MAG-HS 7);
probe ultrasound (Hielscher, UP 200S);
drybox (CINELAB, CE-120/60);
vacuum pump (Fisatom, 820);
laminar flow hood ABNT NBR 13.700 Class 100 and ISO 14.644-1 Class 5 (Filterflux, FLV-656/3);
muffle furnace (Analógica, AN1232); and
drying oven with air circulation (Nabertherm, TR-120).

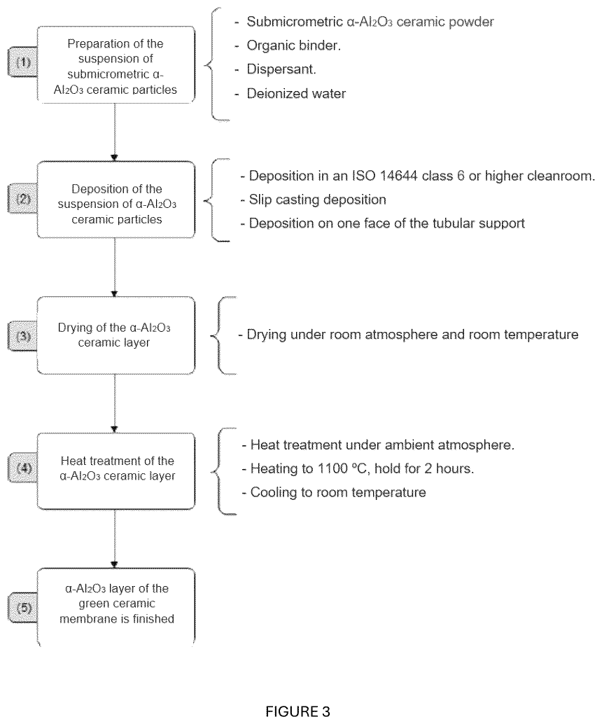

FIG. 3 shows the detailed flowchart of the second step of the process of producing the green ceramic membrane, which corresponds to the process of obtaining the first intermediate ceramic layer of chemical composition alumina in the alpha crystalline phase (α-Al₂O₃). The first intermediate ceramic layer is obtained via slip casting deposition of a suspension of submicrometric α-Al₂O₃ (1) ceramic particles, with an average particle size equal to or greater than the average pore size of the ceramic support (commonly in the range of from 0.7 to 0.9 μm).

First, the ceramic suspension (1) to be deposited onto the support is prepared using a ceramic powder of α-Al₂O₃ particles, at least one organic binder (polyethylene glycol, ethylene glycol, carboxymethyl cellulose, polyvinyl alcohol, or others), at least one dispersing agent (carboxylic acid, humic acid, ammonium polymethacrylate, sodium silicate, etc.) and deionized water as a solvent. All materials used in the preparation of the ceramic suspension of the first intermediate ceramic layer are non-toxic and do not harm the environment, which characterizes the process of obtaining the first intermediate ceramic layer as environmentally friendly and the ceramic layer as a green layer. The ceramic suspension is prepared by mixing all reagents at room pressure and temperature.

Once the suspension of α-Al₂O₃ particles has been prepared, it can be stored at room temperature for long periods of time (up to 12 months) without undergoing changes in its characteristics, which facilitates the industrial production process, since the suspension can be produced in batches, stored and used as needed. Immediately prior to use, the ceramic suspension is prepared by being homogenized under mechanical or ultrasonic stirring, followed by removal of bubbles using vacuum or ultrasound.

Once prepared for use, the ceramic suspension is deposited (2) onto one face of the ceramic support using the slip casting technique, by immersing the green ceramic support into the α-Al₂O₃ particle suspension. The average particle size of the ceramic powder must be selected based on the characteristics (porosity and pore size) of the ceramic support, and optimized so that, after sintering, the resulting coating on the ceramic support provides a gas flow suitable for gas separation processes. These characteristics can be achieved by using a ceramic powder with an average particle size equal to or greater than the average pore size of the ceramic support (typically ranging from 0.7 to 0.9 μm), thus preventing the α-Al₂O₃ particles from clogging the pores of the ceramic support.

During immersion of the ceramic support into the ceramic suspension, capillary forces cause the solvent (water) to penetrate and pass through the ceramic support, leaving the α-Al₂O₃ particles retained on the surface. The time of immersion of the ceramic support into the ceramic suspension is directly proportional to the amount of solid load (α-Al₂O₃ particles) retained on its surface, and accordingly to the thickness of the first intermediate ceramic layer of the green ceramic membrane. The total immersion time of the ceramic support into the α-Al₂O₃ particle suspension will depend on the characteristics (porosity and pore size) of the ceramic support used, and can usually vary from 1 to 5 minutes.

Then the ceramic support assembly and the first intermediate layer are left to dry (3) the excess solvent at room atmosphere and temperature for 24 hours. To ensure quality of the coating, it is preferable that the deposition (2) and drying (3) steps of the first intermediate ceramic layer be performed in a particulate-controlled environment, such as an ISO 14644 class 6 or higher clean room. After drying, sintering (4) is carried out to consolidate the first intermediate ceramic layer. Sintering of the first intermediate ceramic layer of α-Al₂O₃ can be carried out under ambient atmosphere with heating typically up to temperatures in the range of 900 to 1100° C. The dwell time at this temperature can vary according to the desired final porosity, this time being typically 1 to 3 hours. After sintering, the ceramic support coated with the first intermediate green ceramic layer is finished (5) and is ready to proceed to the third stage of the green ceramic membrane production process for CO₂/N₂ and CO₂/CH₄ gas separation, which involves the deposition of the second intermediate green ceramic layer of 7-Al₂O₃.

The procedures described for obtaining the first intermediate ceramic layer of alumina in the alpha crystalline phase (α-Al₂O₃) demonstrate several compelling and robust reasons to be classified as green and environmentally friendly. All materials used in the preparation of the first intermediate ceramic layer are non-toxic and do not harm the environment, which characterizes the process of obtaining it as environmentally friendly and the ceramic layer as a green ceramic layer. The production process is designed to be highly efficient, allowing the ceramic suspension to be stored for long periods of time, hence reducing waste of resources and the need for constant production. This is particularly advantageous from an environmental standpoint, as it avoids excessive consumption of energy and raw materials.

The techniques employed in the production of the ceramic suspension, as well as slip casting used to deposit the ceramic suspension onto the surface of the ceramic support, are efficient processes that do not require complex equipment, thereby reducing energy consumption during the deposition process. Careful selection of the average particle size of the ceramic powder, being optimized to avoid clogging the ceramic support pores, helps to ensure an adequate gas flow for gas separation processes, minimizing waste of material and energy. Sintering of the first intermediate ceramic layer is designed to be adaptable to the intended porosity, which results in a more cost-effective and environmentally friendly approach.

Finally, carrying out the deposition and drying steps of the first ceramic layer in a particle-controlled environment, such as an ISO 14644 class 6 or higher clean room, ensures quality of the coating, avoiding contamination of the process and reducing the need for rework. This not only improves process efficiency but also minimizes residues.

In summary, the production process of the first alumina ceramic intermediate layer exhibits a strong commitment to sustainability through the selection of materials, the use of efficient production methods and careful consideration of process steps to minimize the environmental impact, making it an environmentally friendly option in the gas separation ceramic membrane industry. It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

c) Preparation and Deposition of the Second Intermediate Ceramic Layer of Chemical Composition γ-Al₂O₃

The following reagents and equipment are used to obtain the second intermediate ceramic layer of the green ceramic membrane (3):

### Reagents:

aluminum tri-sec-butoxide 97% (Sigma Aldrich, 201073);
nitric acid (Sigma Aldrich, 438073);
deionized water; and
polyvinyl alcohol PVA 35% (Zschimmer and Schuwarz, PAF 35).

### Equipment:

analytical scale (Shimadzu, AUX-320);
water purifier (Merk, DirectQ 5 UV);
magnetic stirrer with heating (Ika, C MAG-HS 7);
exhaust hood;
laminar flow hood ABNT NBR 13.700 Class 10 and ISO 14.644-1 Class 4 (Cleatech);
dipcoater (Construmaq);
muffle furnace (Analógica, AN1232); and
drying oven with air circulation (Nabertherm, TR-120).

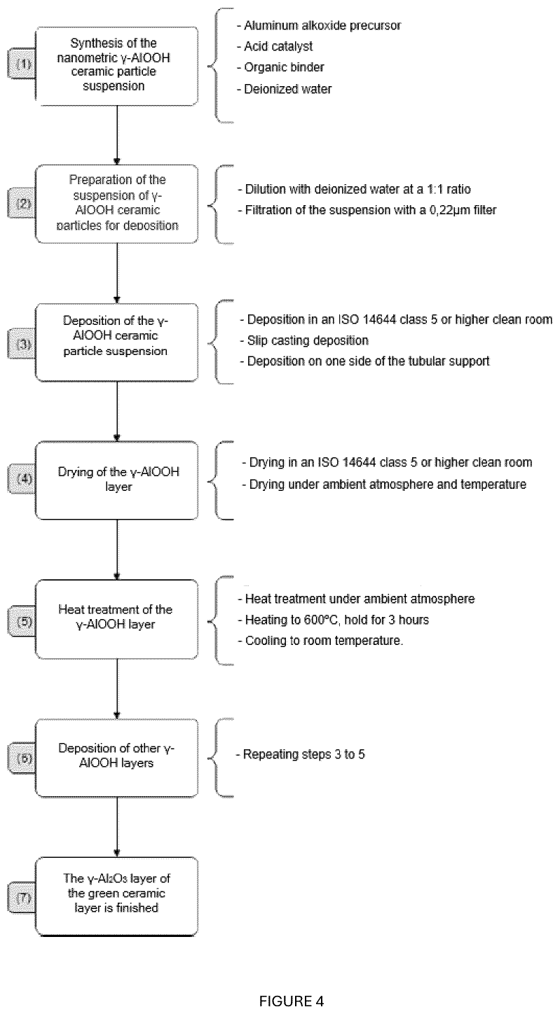

FIG. 4 shows a detailed flowchart of the third step of the green ceramic membrane production process, which corresponds to the process for obtaining the second intermediate ceramic layer composed of alumina in the gamma crystalline phase (γ-Al₂O₃). The second intermediate ceramic layer is obtained via slip casting of a suspension containing nanometric ceramic particles of γ-AlOOH (1), which, upon heat treatment, are crystallized into γ-Al₂O₃.

The ceramic suspension to be deposited on the second intermediate ceramic layer is prepared by the sol-gel method using an aluminum alkoxide precursor, an acid catalyst, at least one organic binder and deionized water as solvent (1). The average size of γ-AlOOH nanoparticles can be controlled by adjusting the synthesis time and temperature in addition to the type and amount of acid catalyst used. The average size of γ-AlOOH nanoparticles will depend on the characteristics (porosity and pore size) of the first intermediate ceramic layer of α-Al₂O₃, and must be optimized so that, after heat treatment, the film formed on the first intermediate ceramic layer exhibits a gas flow suitable for gas separation processes. These characteristics can be achieved by using a suspension of γ-AlOOH nanoparticles with an average particle size equal to or greater than the average pore size of the first intermediate ceramic layer of α-Al₂O₃ (typically in the range of 80 to 100 nm), thus preventing the pores of the underlying layer and the ceramic support from clogging with γ-AlOOH nanoparticles.

During immersion in the suspension of γ-AlOOH nanoparticles, capillary forces cause the solvent (water) to penetrate and pass through the intermediate ceramic layer of α-Al₂O₃, leaving the γ-AlOOH nanoparticles retained on the surface. According to the developed protocol, once prepared, the γ-AlOOH ceramic suspension can be cooled (temperature below −6° C.) and stored for long periods of time (up to 12 months) without changing its characteristics, which facilitates the industrial production process since the suspension can be produced in batches, stored and used as needed. Immediately prior to deposition, the ceramic r-AIOOH suspension is prepared (2) being diluted using deionized water, typically in a volumetric suspension:water ratio of 1:1.

Dilution only at the time of deposition is advantageous in terms of the industrial production process, as it saves space for storing the Γ-AlOOH stock suspension. The volumetric dilution ratio of the Γ-AlOOH ceramic suspension may change according to the need to adjust the thickness of the second intermediate ceramic layer of Γ-Al₂O₃ formed. The thickness of the second intermediate ceramic layer is inversely proportional to the volumetric dilution ratio.

After dilution, the Γ-AlOOH ceramic suspension is then filtered (2) (e.g. with a 0.22 μm filter) to eliminate possible particle agglomerates present in the solution. The pore size of the filter used in the filtration step can vary according to the maximum desired particle size limit. Filtration of the Γ-AlOOH solution prior to its deposition makes it possible to obtain a ceramic film of homogeneous thickness and structure, being less prone to cracking during heat treatment. Elimination of particle agglomerates in the Γ-AlOOH solution also allows for a controlled distribution and size of pores in the Γ-Al₂O₃ film.

After filtration, the γ-AlOOH nanoparticle suspension is deposited (3) onto the first intermediate ceramic layer of α-Al₂O₃ by slip casting by immersing the support and first intermediate ceramic layer assembly into the γ-AlOOH nanoparticle suspension. During immersion into the ceramic suspension, the surface pores of the first intermediate layer become clogged with the γ-AIOOH NANOPARTICLE SUSPENSION, while the solvent (water) passes through the first intermediate layer and the ceramic support wall driven by capillary forces. The immersion time in the ceramic nanoparticle suspension is directly proportional to the amount of solid load (γ-AIOOH NANOPARTICLES) retained on the surface of the first intermediate ceramic layer, and accordingly to the thickness of the second intermediate ceramic layer of the green ceramic membrane.

The total immersion time in the γ-AIOOH NANOPARTICLE SUSPENSION will depend on the characteristics (porosity and pore size) of the first intermediate ceramic layer. The parameters for controlling thickness of the second intermediate ceramic layer must be adjusted to the minimum possible thickness in which a uniform coating is achieved across the entire surface, thus ensuring lower resistance to gas passage and accordingly a higher flow rate in the green ceramic membrane.

The newly deposited layer is dried (4) to remove the excess solvent under ambient atmosphere and at room temperature prior to heat treatment. To ensure the coating quality, the deposition and drying steps should preferably be carried out in a particulate-controlled environment, such as in an ISO 14644 class 5 or higher clean room. Heat treatment of the second intermediate ceramic layer (5) is carried out under ambient atmosphere with heating typically up to a temperature of 600° C. and a dwell time at that temperature for, for example, 3 hours. The heat treatment temperature and the dwell time at the temperature level can be adjusted to promote greater or lesser densification of the second intermediate ceramic layer.

For the developed protocol, the temperature range in which heat treatment can be performed typically ranges from 450° C. to 700° C., in order to ensure sufficient energy for the γ-AlOOH nanoparticles to undergo phase transition and crystallize in the gamma crystalline phase (γ-Al₂O₃). Regarding the dwell time, it can change depending on the need for densification of the formed layer. Densification of the second intermediate ceramic layer is directly proportional to the temperature dwell time during heat treatment. The steps of deposition of the γ-AlOOH nanoparticle suspension (3), drying (4) and heat treatment (5) can be repeated (6) as many times as necessary until a uniform coating is achieved over the entire surface of the first intermediate layer of α-Al₂O₃.

After heat treatment, the ceramic support assembly coated with the first and second intermediate green ceramic layers is finished (7) and ready to proceed to the fourth stage of the production process of the green ceramic membrane for CO₂/N₂ and CO₂/CH₄ gas separation, by depositing the third green ceramic layer, the mesoporous silica ceramic sub-layer.

Among the chemical reagents used in the preparation of the second intermediate ceramic layer of γ-Al₂O₃, those that present risks to the human health and the environment are the aluminum alkoxide precursor and the acid catalyst. Although the precursor reagent aluminum alkoxide is toxic if ingested or in contact with the skin, its toxicity is completely neutralized after reacting with water. This is because when reacting with water the aluminum alkoxide precursor is converted into an alcohol (propanol for aluminum alkoxide isopropoxide, butanol for aluminum alkoxide tri-sec-butoxide, etc.) which is evaporated from the suspension by heating and thereafter recovered by condensation, which enables its reuse, and into hydrated alumina (γ-AlOOH) which poses no risk to the human health or the environment.

Regarding the acid catalyst used, the final amount of such chemical present in the ceramic deposition suspension is considered negligible in relation to the solvent volume (H:H2O molar ratio=1:3000), such that the resulting pH (pH≈6.0) of the suspension is close to or even greater than the pH of various foods ingested by humans. Furthermore, the acid catalyst used in the synthesis of the ceramic suspension can be recovered by distillation and reused in the production process itself. Therefore, the overall process of obtaining the second intermediate ceramic layer of γ-Al₂O₃ can be regarded as environmentally friendly and the ceramic layer as a green ceramic layer.

The use of γ-AlOOH nanoparticles as material for the second intermediate ceramic layer is also highly advantageous, since these nanoparticles can be synthesized in an efficient and controlled manner, minimizing the use of resources and generation of waste. Also, the sol-gel method used is a sustainable chemical approach that allows the synthesis of high-quality materials with low environmental impact. Another important aspect of the preparation of the γ-AlOOH ceramic suspension is that it can be stored for long periods of time, which avoids the waste of material and resources during the production process, contributing to the process efficiency and sustainability. Diluting the ceramic suspension only at the time of deposition is also a cost-effective and environmentally friendly procedure, as it avoids large-scale storage of diluted suspensions, saving both space and resources.

The preparation and deposition of the γ-AlOOH nanoparticle suspension onto the first intermediate ceramic layer of α-Al₂O₃ is carried out by an efficient slip casting method, which does not require complex equipment, high temperatures, or elevated pressures during the preparation and deposition of the suspension, thereby saving energy. Heat treatment of the second intermediate ceramic layer with the possibility of adjusting the temperature and the dwell time according to the densification needs also contributes to energy savings and to obtaining high-quality ceramic layers efficiently.

In summary, production of the second intermediate ceramic layer of γ-Al₂O₃ has a number of features that render it environmentally friendly, including the careful selection of materials, efficient production methods, reduced waste of resources and minimized environmental impact. It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

### d) Synthesis and Deposition of the Ceramic Separation Sub-Layer of the Green Ceramic Membrane, Third Mesoporous SiO₂ Layer

When obtaining the ceramic separation sub-layer of the green ceramic membrane, the third mesoporous SiO₂ layer (4), the following reagents and equipment are used:

### Reagents:

tetraethyl orthosilicate (Sigma Aldrich, 131903);
hydrochloric acid (Merck, 100317);
Anhydrous ethanol (Sigma Aldrich, 459836);
deionized water; and
Triethyl hexammonium bromide (Sigma Aldrich 380830).

### Equipment:

water purifier (Merk, DirectQ 5 UV);
magnetic stirrer with heating (Ika, C MAG-HS 7);
pH meter (Digimed, DM-32);
laminar flow hood ABNT NBR 13.700 Class 10 and ISO 14.644-1 Class 4 (Cleatech);
dipcoater (Construmaq);
muffle furnace (Analógica, AN1232); and
drying oven with air circulation (Nabertherm, TR-120).

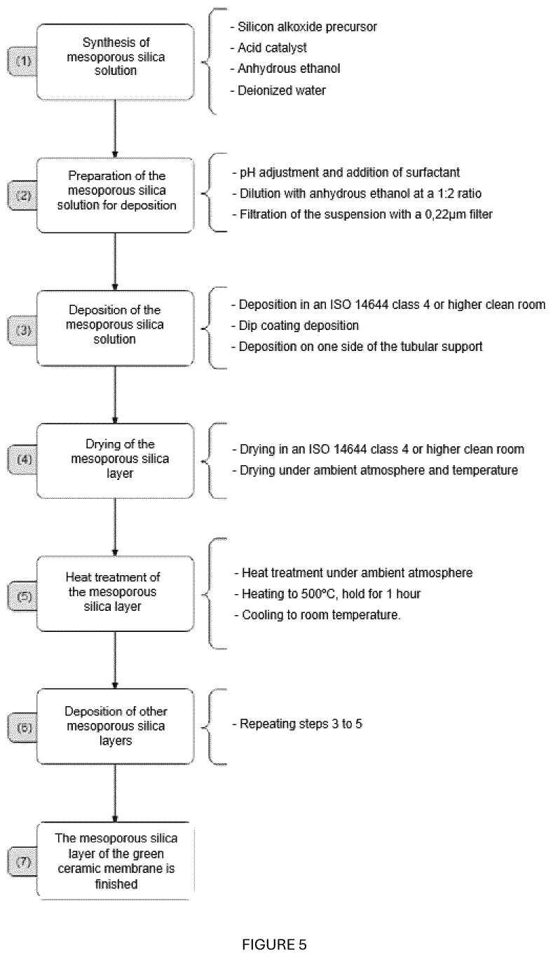

FIG. 5 shows the detailed flowchart of the fourth step of the process for producing the green ceramic membrane, which corresponds to the process of obtaining the separation sub-layer made of amorphous silica (SiO₂). The silica ceramic sub-layer is obtained via dip coating in a solution containing silica polymer chain nanoparticles and a pore-forming agent, which, upon heat treatment, consolidates into a ceramic film composed of a three-dimensional SiO₂ network.

First, a solution of silica polymer chain nanoparticles is prepared by the sol-gel method (1) using a silicon alkoxide (tetramethyl orthosilicate, tetraethyl orthosilicate, tetrapropyl orthosilicate, tetrabutyl orthosilicate, or the like), an acid catalyst (HCl, HNO₃, H₂SO₄, HF, or the like), deionized water and as solvent an alcohol compatible with the alkoxide (methanol for tetraethyl orthosilicate, ethanol for tetraethyl orthosilicate, propanol for tetrapropyl orthosilicate, butanol for tetrabutyl orthosilicate, etc.). Silicon alkoxide in the presence of water and an acid catalyst undergoes chemical reactions of hydrolysis and condensation leading to the formation and growth of inorganic —Si—O—Si— polymeric chains. The average size of such inorganic polymeric chains can be controlled by adjusting the synthesis time (typically in the range of 60 to 180 minutes) and temperature (typically in the range of 0 to 60° C.) in addition to the type and level of acid catalyst used.

As the polymer chains grow, they coil and package, generating nanoparticles of silica polymer chains. The average size of the silica polymer chain nanoparticles will depend on the characteristics (porosity and pore size) of the second intermediate ceramic layer of γ-Al₂O₃, and must be optimized so that, after heat treatment, the resulting film exhibits a gas flow suitable for gas separation processes. Such characteristic can be achieved by using a solution whose average size of the silica polymer chain nanoparticles is equal to or greater than the average pore size of the second intermediate layer of Γ-Al₂O₃ (typically in the range of from 4 to 20 nm), thus preventing the pores of the lower layers (support, first and second intermediate layers) from being clogged by the solution of silica polymer chain nanoparticles.

Therefore, the porosity gradient between the ceramic support and the silica sub-layer is maintained, ensuring an appropriate gas flow for gas separation. Following the developed protocol, once prepared, the solution of silica polymer chain nanoparticles can be frozen (temperature usually in the range of from −25 to −30° C.) and stored for several months (up to 12 months) without changing its characteristics, which facilitates the industrial production process since the suspension can be produced in batches, stored and used as needed.

Prior to use, the solution of silica polymer chain nanoparticles is prepared (2) by correcting the solution pH to the isoelectric point of silica (pH≈2.0), and by adding a surfactant, which will serve as a pore-forming agent in the silica sub-layer. Surfactants are amphipathic molecules whose chemical structure is formed by a nonpolar chain (hydrophobic tail) with one of its polar ends (hydrophilic head). When added to the solution containing silica polymer chain nanoparticles (polar solution), the surfactant molecules organize themselves to form micelles, which, during heat treatment, are degraded and eliminated from the ceramic film, generating a pore network (mesopores).

Immediately before deposition, the silica solution containing a porogenic agent is diluted using an alcohol (the same as used in the synthesis) at a solution:alcohol volumetric ratio of, for example, 1:2. Dilution only at the time of deposition is advantageous in terms of the industrial production process, as it saves space for storing the stock solution of silica polymeric chain nanoparticles. The volumetric dilution ratio of the silica solution with porogenic agent may change according to the need to adjust the silica sub-layer thickness. The thickness of the silica ceramic sub-layer is inversely proportional to the volumetric dilution ratio.

After dilution, the silica solution containing the porogenic agent is then filtered (e.g., with a 0.22 μm filter) to eliminate possible bulky agglomerates of polymeric silica nanoparticles present in the solution. The pore size of the filter used in the filtration step can vary according to the maximum desired particle size limit. Filtration of the solution of silica with porogenic agent prior to its deposition enables the preparation of a ceramic film of homogeneous thickness and structure, being less prone to cracking during heat treatment.

After filtration, the solution is deposited (3) on the second intermediate ceramic layer of γ-Al₂O₃ via dip coating by immersing the support assembly, the first and second intermediate ceramic layers into the solution of polymeric silica nanoparticles with porogenic agent and immediately withdrawing it at a predefined speed, according to the desired layer thickness, the thickness being directly proportional to the withdrawal speed. The parameters for controlling thickness of the silica sub-layer must be adjusted to the minimum possible thickness in which a uniform coating is achieved across the entire surface, thus ensuring lower resistance to gas passage and accordingly a higher flow rate in the green ceramic membrane. The newly deposited layer is dried (4) to remove the excess solvent under ambient atmosphere and at room temperature prior to heat treatment.

To ensure the coating quality, the deposition and drying steps of the second intermediate ceramic layer should preferably be carried out in a particulate-controlled environment, such as in an ISO 14644 class 4 or higher clean room. Heat treatment (5) of the mesoporous silica ceramic sub-layer is carried out under ambient atmosphere with heating, for example, up to a temperature of 500° C. and a dwell time at that temperature for, for example, 1 hour. The heat treatment temperature and the dwell time at the temperature level can be adjusted to promote greater or lesser densification of the mesoporous silica ceramic sub-layer.

For the developed protocol, the temperature range at which heat treatment can be performed can typically range from 300° C. to 600° C., in order to ensure that volatiles and organics (synthesis residues, pore-forming agent) are fully eliminated from the silica network and ensure its structural stability. Regarding the dwell time, it may change depending on the need for densification of the formed layer, and may range from 1 to 3 hours, for example. Densification of the mesoporous silica ceramic sub-layer is directly proportional to the temperature dwell time during heat treatment.

The steps of deposition of the silica mesoporous solution (3), drying (4) and heat treatment (5) can be repeated (6) as many times as necessary until a uniform coating is achieved over the entire surface of the second intermediate layer of γ-Al₂O₃. After heat treatment, the ceramic support assembly coated with the first and second intermediate green ceramic layers and with the silica mesoporous sub-layer is finished (7) and ready to proceed to the fifth stage of the production process of the green ceramic membrane for CO₂/N₂ and CO₂/CH₄ gas separation, by depositing the fourth and last green ceramic layer, the microporous silica ceramic sub-layer.

The low toxicity of the reagents used in the process of producing the mesoporous silica sub-layer is an essential feature that contributes significantly to classifying the process as green and environmentally friendly. This is a critical criterion for minimizing negative impacts and risks associated with exposure to hazardous chemicals. The list of reagents used in the production process of the mesoporous silica sub-layer includes aluminum and aluminum alkoxides and silica, acids, alcohols, in addition to surfactants. These substances are routinely used in the chemical industry and are well known for their low toxicity when handled correctly as per safety and environmental protection standards.

Another important issue to be considered is the reuse of the acids used in the sol-gel synthesis of the mesoporous silica sub-layer, as this is a relevant aspect that contributes to making the production process of ceramic membranes even more sustainable and environmentally friendly. Description of the process mentions the use of acids such as HCl, HNO₃, H₂SO₄, HF, among others, as catalysts for the sol-gel synthesis of silica polymer chain nanoparticles. Since these reagents are used as catalysts, they are not consumed during the reactions that form the three-dimensional silica network and can therefore be easily recovered and reused.

The ability to recover these acids after synthesis is advantageous for several reasons. First, acid recovery reduces the waste of chemical resources and minimizes the costs associated with purchasing new reagents. This is economically beneficial for industrial operations, as acids can be expensive. The reuse of acids in the sol-gel synthesis is also beneficial, as it contributes to maintaining more efficient and sustainable production levels. By using recovered acids, industrial operations save resources and minimize the chemical waste generated.

The synthesis of silica polymer chain nanoparticles using the sol-gel method is a sustainable chemical approach, which allows the production of high-quality ceramic material with low environmental impact. The nanoparticle average size is precisely controlled to optimize them to meet the gas flow needs in the membrane, minimizing waste of material and resources. Addition of a surfactant as a pore-forming agent is an efficient approach as it allows the formation of a pore network in the mesoporous silica sub-layer. The surfactant is degraded during heat treatment, thereby preventing the formation of environmentally harmful residues.

The process of freezing and storing the silica nanoparticle solution for several months without changing its characteristics also contributes to the efficiency of the production process, reducing the consumption of resources and generation of residues. Furthermore, dilution of the silica solution only at the time of deposition is cost-effective approach that avoids large-scale storage of diluted solutions, resulting in savings in space and resources.

The techniques for preparing the silica solution and its deposition by immersion (dip coating) allows the silica sub-layer to be obtained efficiently, without the need for complex equipment that demands high temperatures or pressures, hence saving energy and resources. Furthermore, heat treatment of the silica sub-layer can be adjusted to promote its densification according to the process requirements, ensuring energy efficiency.

In summary, the process of producing the silica sub-layer has a series of practices and characteristics that make it environmentally friendly, including the choice of sustainable materials, efficient production methods, reduction of resource waste and minimization of environmental impact. It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

### e) Synthesis and Deposition of the Ceramic Separation Sub-Layer of the Green Ceramic Membrane, Fourth Microporous SiO₂ Layer

The following reagents and equipment are used to obtain the ceramic separation layer of the green ceramic membrane, the fourth microporous SiO₂ layer (5):

### Reagents:

tetraethyl orthosilicate (Sigma Aldrich, 131903);
hydrochloric acid (Merck, 100317);
Anhydrous ethanol (Sigma Aldrich, 459836); and
deionized water.

### Equipment:

water purifier (Merk, DirectQ 5 UV);
magnetic stirrer with heating (Ika, C MAG-HS 7);
pH meter (Digimed, DM-32);
laminar flow hood ABNT NBR 13.700 Class 10 and ISO 14.644-1 Class 4 (Cleatech);
dipcoater (Construmaq); and
muffle furnace (Analógica, AN1232).

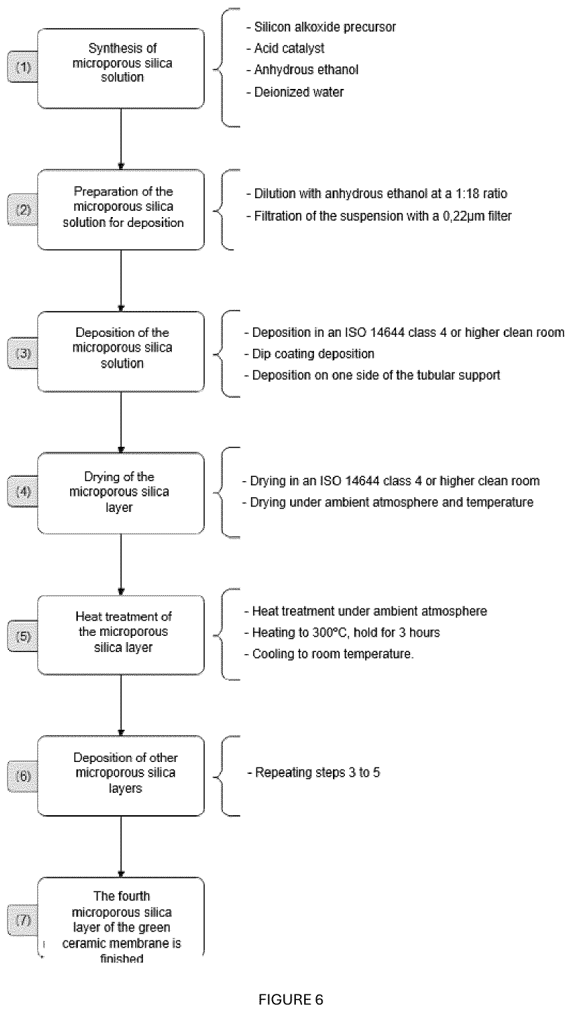

FIG. 6 shows the detailed flowchart of the fifth step of the process for producing the green ceramic membrane, which corresponds to the process of obtaining the selective ceramic layer comprising microporous amorphous silica (SiO₂). The selective ceramic layer of microporous silica is obtained via dip coating in a solution containing silica polymer chain nanoparticles, which, upon heat treatment, consolidates into a ceramic film composed of a three-dimensional SiO₂ network. Improved gas separation efficiency in the green ceramic membrane is achieved when the selective ceramic layer comprises of four depositions of the ceramic coating of microporous silica. The total number of coatings forming the selective ceramic layer to achieve suitable selectivity and permeance values for gas separation may vary (typically from 2 to 6 coatings) according to the parameters used in the production process.

First, a solution of silica polymer chain nanoparticles is prepared by the sol-gel method (1) using a silicon alkoxide (tetramethyl orthosilicate, tetraethyl orthosilicate, tetrapropyl orthosilicate, tetrabutyl orthosilicate, or the like), an acid catalyst (HCl, HNO₃, H₂SO₄, HF, or the like), deionized water and as solvent an alcohol compatible with the alkoxide (methanol for tetraethyl orthosilicate, ethanol for tetraethyl orthosilicate, propanol for tetrapropyl orthosilicate, butanol for tetrabutyl orthosilicate, etc.). Silicon alkoxide in the presence of water and an acid catalyst undergoes chemical reactions of hydrolysis and condensation leading to the formation and growth of inorganic —Si—O—Si— polymeric chains. The average size of such inorganic polymeric chains can be controlled by adjusting the synthesis time (typically in the range of 60 to 180 minutes) and temperature (typically in the range of 0 to 60° C.) in addition to the type and level of acid catalyst used.

As the polymer chains grow, they coil and package, generating nanoparticles of silica polymer chains. The average size of the silica polymer chain nanoparticles will depend on the characteristics (porosity and pore size) of the mesoporous silica sub-layer, and must be optimized so that, after heat treatment, the resulting film exhibits a gas flow suitable for gas separation processes. Such characteristic can be achieved by using a solution whose average size of the silica polymer chain nanoparticles is equal to or greater than the average pore size of the mesoporous silica sub-layer (typically 2 nm), thus preventing the pores of the lower layers (support, first and second intermediate layers and mesoporous silica sub-layer) from being clogged by the solution of silica polymer chain nanoparticles.

Therefore, the porosity gradient between the ceramic support and the selective microporous silica layer is maintained, ensuring an appropriate gas flow for gas separation. According to the developed protocol, once prepared, the solution of silica polymer chain nanoparticles can be frozen (temperature usually in the range of from −25 to −30° C.) and stored for several months (up to 12 months) without changing its characteristics, which facilitates the industrial production process since the suspension can be produced in batches, stored and used as needed. Prior to use, the solution of silica polymer chain nanoparticles is prepared (2) by correcting the solution pH to the isoelectric point of silica (pH≈2.0), dilution and filtration. Immediately before deposition, the silica solution is diluted using an alcohol (the same as used in the synthesis) at a solution:alcohol volumetric ratio of, for example, 1:18.

Dilution only at the time of deposition is advantageous in terms of the industrial production process, as it saves space for storing the stock solution of silica polymeric chain nanoparticles. The volumetric dilution ratio of the silica solution may change according to the need to adjust the thickness of the selective silica layer. The thickness of the silica ceramic layer is inversely proportional to the volumetric dilution ratio. After dilution, the silica solution is then filtered (e.g., with a 0.22 μm filter) to eliminate possible bulky agglomerates of polymeric silica nanoparticles present in the solution. The pore size of the filter used in the filtration step can vary according to the maximum desired particle size limit. Filtration of the silica solution prior to its deposition makes it possible to obtain a ceramic film of homogeneous thickness and structure, being less prone to cracking during heat treatment.

After filtration, the solution is deposited (3) on the mesoporous silica sub-layer via dip coating by immersing the support assembly, the first and second intermediate ceramic layers and the mesoporous silica sub-layer into the solution of polymeric silica nanoparticles and immediately withdrawing it at a predefined speed, according to the desired layer thickness, the thickness being directly proportional to the withdrawal speed. The parameters for controlling thickness of the selective microporous silica layer must be adjusted to the minimum possible thickness in which a uniform coating is achieved across the entire surface, thus ensuring lower resistance to gas passage and accordingly a higher flow rate in the green ceramic membrane.

The newly deposited layer is dried (4) to remove the excess solvent under ambient atmosphere and at room temperature prior to heat treatment. To ensure the coating quality, the deposition and drying steps should preferably be carried out in a particulate-controlled environment, such as for example, an ISO 14644 class 4 or higher clean room. Heat treatment (5) of the microporous silica ceramic sub-layer is carried out under ambient atmosphere with heating, for example, up to a temperature of 300° C. and a dwell time at that temperature for, for example, 1 hour. The heat treatment temperature and the dwell time at the temperature level can be adjusted to promote greater or lesser densification of the microporous silica ceramic sub-layer.

For the developed protocol, the temperature range in which heat treatment can be performed can typically range from 200° C. to 400° C., in order to ensure that the volatiles and organics (synthesis residues) are completely eliminated from the silica network and guarantee its structural stability and pore sizes appropriate for CO₂ separation (typically less than 0.4 nm). Regarding the dwell time, it may change depending on the need for densification of the formed layer, and may range from 1 to 3 hours, for example. Densification of the microporous silica ceramic layer is directly proportional to the temperature dwell time during heat treatment. The steps of deposition of the microporous silica solution (3), drying (4) and heat treatment (5) can be repeated (6) as many times as necessary until a uniform coating is obtained over the entire surface of the mesoporous silica sub-layer.

After heat treatment, the ceramic support assembly coated with the first and second intermediate ceramic layers, ceramic sub-layer of mesoporous silica and selective ceramic layer of microporous silica is finished and ready for CO₂/N₂ and CO₂/CH₄ gas separation, and can be designated as green ceramic gas separation membrane (7).

The low toxicity of the reagents used in the process of producing the selective ceramic layer of microporous silica is an essential feature that contributes significantly to classifying the process as green and environmentally friendly. This is a critical criterion for minimizing negative impacts and risks associated with exposure to hazardous chemicals. The list of reagents used in the production process of the mesoporous silica sub-layer includes aluminum and silicon alkoxides, acids and alcohols. These substances are routinely used in the chemical industry and are well known for their low toxicity when handled correctly as per safety and environmental protection standards.

Another important issue to be considered is the reuse of the acids used in the sol-gel synthesis of the selective ceramic layer of microporous silica, as this is a relevant aspect that contributes to making the production process of ceramic membranes even more sustainable and environmentally friendly. Description of the process mentions the use of acids such as HCl, HNO₃, H₂SO₄, HF, among others, as catalysts for the sol-gel synthesis of silica polymer chain nanoparticles. Since these reagents are used as catalysts, they are not consumed during the reactions that form the three-dimensional silica network and can therefore be easily recovered and reused. The ability to recover these acids after synthesis is advantageous for several reasons. First, acid recovery reduces the waste of chemical resources and minimizes the costs associated with purchasing new reagents. This is economically beneficial for industrial operations, as acids can be expensive. The reuse of acids in the sol-gel synthesis is also beneficial, as it contributes to maintaining more efficient and sustainable production levels. By using recovered acids, industrial operations save resources and minimize the chemical waste generated.

The synthesis of silica polymer chain nanoparticles using the sol-gel method is a sustainable chemical approach that allows the production of high-quality ceramic material with low environmental impact. The nanoparticle average size is precisely controlled to optimize them to meet the gas flow needs in the membrane, minimizing waste of material and resources.

The process of freezing and storing the silica nanoparticle solution for several months without changing its characteristics also contributes to the efficiency of the production process, reducing the consumption of resources and generation of residues. Furthermore, dilution of the silica solution only at the time of deposition is cost-effective approach that avoids large-scale storage of diluted solutions, resulting in savings in space and resources.

The techniques for preparing the silica solution and its deposition by immersion (dip coating) allows the selective ceramic silica layer efficiently, without the need for complex equipment that demands high temperatures or pressures, hence saving energy and resources. Furthermore, heat treatment of the selective ceramic layer can be adjusted to promote its densification according to the process requirements, ensuring energy efficiency.

In summary, the process of producing the selective ceramic layer of microporous silica has a series of practices and characteristics that make it environmentally friendly, including the choice of sustainable materials, efficient production methods, reduction of resource waste and minimization of environmental impact. It is also important to highlight that the end product is comprised of oxides, which are environmentally friendly, non-toxic, non-polluting, and reusable. This represents a significant advantage by allowing for waste reduction and the conservation of natural resources. Overall, ceramic oxides have demonstrated to be a sustainable and environmentally friendly option compared to many other materials used in the manufacture of gas separation membranes.

### Application of the Invention

Removal of carbon dioxide (CO₂) from gas streams is a requirement in several industries due to environmental, product quality and regulatory reasons. The process for preparing a green ceramic membrane (GCM) for CO₂ separation of the present invention, can be applied in the following fields without the need for modifications:
1. Oil and gas industry: The green ceramic membrane prepared according to the process of the present invention can be efficiently used for the removal of gaseous CO₂ from natural gas at the topside, contributing to the production of high-quality gas, improved operational efficiency, and compliance with environmental regulations.
2. CO₂ removal of exhaust gas: The separation of carbon dioxide (CO₂) of exhaust gases is critical for reducing carbon emissions and mitigating climate change. The green ceramic membrane prepared according to the process of the present invention can be used to capture CO₂ from exhaust gas streams, allowing their underground storage or use in industrial processes (He X, Chen D, Liang Z, Yang F. Insight and comparison of energy-efficient membrane processes for CO2 capture from flue gases in power plant and energy-intensive industry. Carbon Capture Sci Technol 2022; 2:100020).
3. Capture of CO₂ directly from air: Direct air capture of carbon dioxide (CO₂) is a technology designed to remove CO₂ from the Earth's atmosphere. This approach is considered an important part of strategies to fight climate changes and mitigate the rising levels of CO₂ in the atmosphere. The green ceramic membrane prepared according to the process of the present invention can be used in the direct capture of CO₂ from air for its subsequent use in different sectors of the industry or geological storage (Castel C, Bounaceur R, Favre E. Membrane processes for direct carbon dioxide capture from air: Possibilities and limitations. Front Chem Eng 2021; 3:1-15; Ozkan M, Nayak S P, Ruiz A D, Jiang W. Current status and pillars of direct air capture technologies. IScience 2022; 25:103990).
4. Biogas purification and biomethane production: The green ceramic membrane prepared according to the process of the present invention can be used to separate CO₂ from biogas, resulting in high quality gas having reduced CO₂ content, classified as biomethane.

This is critical because CO₂ is an important contaminant in biogas, which can affect combustion efficiency and reduce the calorific value of the gas. Furthermore, removal of CO₂ is essential to meet regulatory and quality standards for biomethane (Baena-Moreno F M, le Saché, Pastor-Pérez L, Reina T R. Membrane-based technologies for biogas upgrading: A review. Environ Chem Lett 2020; 18:1649-58; Nithin Mithra S, Ahankari S S. Nanocellulose-based membranes for CO2 separation from biogas through the facilitated transport mechanism: a review. Mater Today Sustain 2022; 19:100191; Khan M U, Lee J T E, Bashir M A, Dissanayake P D, Ok Y S, Tong Y W, et al. Current status of biogas upgrading for direct biomethane use: A review. Renew Sustain Energy Rev 2021; 149:111343).
5. Cement industry: During the process for manufacturing cement, limestone is heated in a furnace to produce cement clinker, releasing CO₂ as a by-product. The green ceramic membrane prepared according to the process of the present invention can be used to capture CO₂ released during calcination of limestone and also exhaust gases. This capture can be carried out directly during the cement manufacturing process, helping to reduce CO₂ emissions (Guo Y, Luo L, Liu T, Hao L, Li Y, Liu P, et al. A review of low-carbon technologies and projects for the global cement industry. J Environ Sci (China) 2023; 136:682-97).
6. Food and beverage industry: Carbon dioxide is widely used in the food industry to extend the shelf life of food products and maintain their quality. It also plays an essential role in the beverage industry, contributing to the flavor, texture and preservation of a variety of products, from soft drinks to beers and spirits. The green ceramic membrane prepared according to the process of the present invention can be used in obtaining and purifying CO₂ for food preservation and freezing or carbonation of carbonated beverages (Ozkan M, Nayak S P, Ruiz A D, Jiang W. Current status and pillars of direct air capture technologies. IScience 2022; 25:103990; Wang W, Rao L, Wu X, Wang Y, Zhao L, Liao X. Supercritical carbon dioxide applications in food processing. Food Eng Rev 2021; 13:570-91).
7. Agriculture: The use of carbon dioxide (CO₂) in greenhouse planting is a common agricultural practice that can significantly improve plant growth and yield. This technique is known as CO₂ enrichment and involves increasing the CO₂ concentration in the greenhouse atmosphere to levels greater than those found in the ambient atmosphere. The green ceramic membrane prepared according to the process of the present invention can be used in the selective separation of CO₂ to be subsequently injected into greenhouses to improve crop growth, quality and yield (Thomson A, Price G W, Arnold P, Dixon M, Graham T. Review of the potential for recycling CO2 from organic waste composting into plant production under controlled environment agriculture. J Clean Prod 2022; 333:130051).
8. CO₂ concentration in photosynthesis and aerobic fermentation: In anaerobic fermentation processes or in systems involving photosynthetic organisms, such as algae, CO₂ can serve as a critical input for the growth and metabolism of microorganisms (Kajla S, Kumari R, Nagi G K. Microbial CO₂ fixation and biotechnology in reducing industrial CO₂ emissions. Arch Microbiol 2022; 204:1-20). The green ceramic membrane prepared according to the process of the present invention can be used to concentrate and supply CO₂ directly to microorganisms, increasing the fermentation process efficiency.

Furthermore, it is highlighted that the green ceramic membrane prepared according to the process of the present invention was designed with a pore structure optimized to separate CO₂ from natural gas on the topside, where the gas is in a gaseous state. However, this membrane has the potential to be applied in CO₂ separation from natural gas in subsea environments, where gases are in a supercritical state. To enable this expanded use, it is necessary to tailor the membrane's pore structure, making it suitable for the separation of fluids in the supercritical state. Moreover, with appropriate adaptations, the green ceramic membrane is also effective in removing other contaminants from natural gas, such as H2S and moisture, both in the topside and in subsea environment. Another possible application of the green ceramic membrane in the oil and gas industry is in the production of hydrogen in steam reforming of natural gas. In this process, natural gas is reacted with steam in the presence of a catalyst to produce hydrogen and carbon monoxide (CO). The produced hydrogen needs to be separated from the CO and then used in oil refining processes such as hydrogenation, hydrotreating and hydrocracking (Lei L, Lindbrâthen A, Hillestad M, He X. Carbon molecular sieve membranes for hydrogen purification from a steam methane reforming process. J Memb Sci 2021; 627:119241; Akbari A, Omidkhah M. Silica-zirconia membrane supported on modified alumina for hydrogen production in steam methane reforming unit. Int J Hydrogen Energy 2019; 44:16698-706). This potential versatility of the green ceramic membrane makes it a valuable tool for improving natural gas quality under diverse operating conditions, expanding its applications in different industrial scenarios.

Although the green ceramic membrane (GCM) prepared according to the process of the present invention was originally developed for the selective separation of CO₂ from natural gas, it can be tailored for the separation of other gases with some specific modifications in its structure and composition. To make this adaptation possible, some adjustments to the membrane's selective layer are required. This may involve the following modifications:
Pore size: The pore size in the membrane can be changed to allow the selective passage of other gases according to the molecular size of those gases. This involves adjusting the pore size in a controlled manner by modifying different variables in the sol-gel synthesis of the selective layer, such as the chemical composition, reagent type and concentration, solution pH, temperature and synthesis time. The parameters used in the heat treatment of the selective layer also affect its pore structure, and time and temperature can be adjusted to better control the pore size. Pore size control can also be achieved by introducing surfactants or porogenic agents into the sol-gel synthesis of the selective layer. Through a careful combination of process parameters, the pore size of the selective layer produced by the sol-gel method can be adjusted. Such ability to precisely control pore size is one of the technical advantages used in the preparation of the green ceramic membrane of the present invention, making it particularly useful in the production of gas separation membranes with customized nanometric structures for various applications.
Composition of the selective layer: The composition of the selective layer plays a critical role in the membrane efficiency for separating gases. Careful selection of ceramic materials is crucial, considering specific properties such as compatibility and chemical affinity with the target gases. In addition to the traditional use of silica, the choice of materials such as zirconia or titania can be considered, depending on the gases to be separated. The selective layer can also be designed with a composition comprised of a mixture of two or more oxides, allowing its pore structure to be optimized for an effective gas separation.
Functionalization: Functionalization of the selective layer of the green ceramic membrane developed in the present invention provides specificity for the separation of target gases. Such functionalization can be carried out by incorporating chemical groups with affinity for a certain target gas during the sol-gel synthesis of the selective layer or by grafting. In addition to improving selectivity, functionalization contributes to both chemical and thermal stability of the membrane, which is extremely relevant in applications involving corrosive gases. Among the organic groups that can be used in the functionalization of the green ceramic membrane, the following stand out: amines, silanes, carboxylic acids, aldehydes and sulfonic groups.

It is important to emphasize that membrane modification must be carefully planned and tested under controlled conditions to ensure that it meets the specific desired gas separation requirements. Successful adaptation of the green ceramic membrane for separation of other gases can significantly expand its applicability and utility in various industries and processes.

In summary, use of the green ceramic membrane prepared according to the process of the present invention is a comprehensive solution to address the main difficulties associated with the use of polymeric membranes. Said green ceramic membrane stands out by not exhibiting plasticization, demonstrating superior chemical and mechanical strength, offering long-term stability, reducing the need for dehydration and desulfurization steps, allowing backwashing to minimize fouling, providing an extended service life, generating 100% reusable waste and causing a lower environmental impact with a reduced carbon footprint. In addition, it can operate with permeate at high pressures, requiring smaller compressors for reinjection of the CO₂-rich stream into the well, resulting in more compact natural gas treatment units with lower energy consumption.

### Advantages of the Invention

The use of the green ceramic membrane (GCM) prepared according to the process of the present invention for the separation of CO₂ from natural gas (NG) offers several advantages, including economic benefits compared to polymeric membranes (PM), health and safety improvements for both oil and gas industry staff and the environment, advantages in terms of reliability compared to traditionally used polymeric membranes (PM), significant environmental advantages compared to conventional technologies such as polymeric membranes, social benefits, the main ones being:

### Economic Advantages/Productivity

Reduced operational costs: GCM has a significantly longer service life (>20 years) than PM (3 to 5 years). A longer service life is directly linked to a reduced number of operational stops to change filter elements, ensuring lower maintenance costs.
Energy savings: Due to the GCM's ability to operate under higher pressures in the permeate stream, smaller compressors are required for reinjection of the CO₂-rich stream into the well. This reduces energy consumption, which is economically advantageous.
Compact NG processing unit: The reduced need for large compressors enables the NG processing unit to be designed more compactly. This saves space on the platform, which can be essential, and reduces infrastructure-associated costs.
Waste reduction: GCM waste can be fully reused in other industrial sectors, eliminating the need for disposal in landfills. This is not only enviromentally beneficial, but it can also represent a source of revenue through the sale of such waste to other industries.
Lower maintenance costs: GCM's chemical and mechanical strength reduces the need for frequent maintenance due to chemical damage or degradation. This results in fewer process interruptions and lower maintenance costs.
Increased productivity: Due to its greater stability and reduced maintenance requirements, the ceramic membrane can operate continuously for long periods of time, increasing the overall productivity of the NG processing unit.
Reduced greenhouse gas emissions: The energy savings and reduced carbon footprint associated with the use of GCM contribute to a reduced greenhouse gas emissions, which can be advantageous in terms of compliance with environmental regulations and green marketing.
Possibility of reducing pre-treatment steps: GCM can selectively remove moisture and H₂S from NG, reducing additional pretreatment steps. This reduces costs and operational complexity.
Sustainability: GCM's backwash capability, together with the recyclability of its waste, contributes to a more sustainable approach, which is valued by investors and regulatory authorities.

In summary, use of the green ceramic membrane (GCM) prepared according to the process of the present invention not only improves efficiency of the process for separating CO₂ from natural gas, but also offers several economic advantages, including reduced operational costs, energy savings, reduced space requirements, reduced waste and increased productivity, making it an economically attractive option for the oil and gas industry.

### Health/Safety Benefits

Lower flammability risk: Unlike polymeric membranes, the materials used in the GCM are non-flammable, thereby reducing the risk of fire or explosion and enhancing the safety of both facilities and personnel.
Chemical and mechanical stability: GCM's chemical and mechanical stability contributes to its durability and resistance in harsh industrial environments such as acidic or alkaline environments. This reduces the risk of leaks or failures that could pose threats to the health and safety of personnel.
Lower maintenance requirements: GCM's mechanical and chemical strength reduces the need for frequent maintenance, minimizing personnel exposure to potentially hazardous environments and lowering maintenance costs.
Reduced greenhouse gas emissions: The energy savings associated with the use of GCM contribute to a reduction in greenhouse gas emissions, which is beneficial for the public health in terms of air quality and fighting climate changes.
Bioinert materials: Materials that can be present in the final GCM composition, such as alumina and silica, are non-toxic and bioinert materials that pose no risk to human health or the environment. Such materials are commonly used in dentistry and orthopedics in the form of implants, coatings, sensors and medical devices in addition to many other health-related applications (Punj S, Singh J, Singh K. Ceramic biomaterials: Properties, state of the art and future prospectives. Ceram Int 2021; 47:28059-74).
Non-hazardous and reusable waste: GCM waste can be fully reused in other industrial sectors, eliminating the need to dispose of them as hazardous waste. This reduces the risk of environmental contamination, and the health risks associated with handling hazardous waste.
Lower environmental impact: The reduced carbon footprint and the more sustainable approach of the CO₂ separation process using the GCM contribute to environmental preservation, which, in turn, has a positive impact on public health.
Enhanced safety in the workplace: Reducing the need for frequent maintenance along with more stable and predictable operations can enhance safety in the workplace by reducing the risk of accidents and injuries.
Regulatory compliance: Adopting safer and more sustainable technologies, such as GCM, can help companies comply with environmental and health and safety regulations more easily, avoiding fines and sanctions.

In summary, the use of the green ceramic membrane (GCM) prepared according to the process of the present invention not only provides economic advantages but also contributes to improving the health and safety of personnel and reduces the environmental impact, making it a safer and more sustainable option for the oil and gas industry.

### Reliability:

Chemical resistance: Unlike polymeric membranes, the green ceramic membrane is highly resistant to aggressive chemicals such as acids and bases. Such chemical resistance ensures long-term durability and stability.
Long-term stability: The green ceramic membrane has greater long-term stability than polymeric membranes. This means it maintains its effective performance over a much longer period of time without suffering significant degradation, resulting in fewer downtimes and maintenance, increasing reliability of the CO₂ separation process.
Resistance to plasticization: The polymeric membranes undergo plasticization in the presence of high concentrations of CO₂ and high pressures, which can negatively affect their selectivities.

Due to its solid structure and strong chemical bonds, the green ceramic membrane is not susceptible to plasticization, ensuring consistency in performance over time.
Backwashing: The porous structure of the green ceramic membrane allows backwash operations to be carried out to remove fouling and contaminants. This helps maintain the membrane efficiency and extend its service life, which is an important feature in terms of reliability.
Resistance to harsh conditions: The green ceramic membrane can operate under more stringent conditions, including high CO₂ concentrations, high pressures and high temperatures (greater than 200° C.), which is a significant advantage in challenging situations.
Waste reduction: The waste generated by the green ceramic membrane is 100% reusable in other industrial sectors, which not only reduces the environmental impact but also avoids the need for disposal in landfills, contributing to a more sustainable approach.

In summary, the green ceramic membrane (GCM) prepared according to the process of the present invention provides greater reliability due to its chemical resistance, long-term stability, ability to withstand adverse conditions, non-susceptibility to plasticization and greater ease of maintenance. This results in a more robust process for CO₂ separation with fewer operational downtimes and greater consistency in performance over time.

### Environmental Advantages

Extended service life: The green ceramic membrane is estimated to have a service life greater than 20 years, which is much longer than that of polymeric membranes, which usually last less than 5 years. Fewer membrane replacements over time means less waste production and less consumption of natural resources in the manufacture of new membranes.
Reusable waste: The waste from green ceramic membranes can be fully reused in other industrial sectors, such as the ceramics industry, civil construction, paving and cement industries. This eliminates the need for waste disposal in landfills and contributes to a more sustainable approach.
Reduced extraction of natural resources: Reusing green ceramic membrane waste reduces the demand for natural raw materials such as sand, gravel and limestone, which are often used in civil construction. This preserves natural resources and avoids environmental impacts associated with the extraction, such as soil degradation and the destruction of biomes.
Lower energy consumption: The green ceramic membrane can be operated under lower pressure differences (AP) between feed and permeate compared to polymeric membranes. This reduces the need for high-powered compressors to raise the permeate pressure back to adequate levels. Less energy is consumed in this process, hence reducing emissions of carbon dioxide (CO₂) and other air pollutants associated with power generation.
Lower carbon footprint: The reduced energy consumption and less waste generation with the use of the green ceramic membrane contribute to a lower carbon footprint in the natural gas production chain.
Environmentally friendly process: Manufacture of the green ceramic membrane involves processing steps that produce fewer air pollutants and liquid effluents compared to more complex manufacturing processes such as the production of synthetic polymers. This contributes to a lower environmental impact.

In summary, use of the green ceramic membrane prepared according to the process of the present invention in the separation of CO₂ from natural gas not only improves process efficiency but also contributes to reducing greenhouse gas emissions and the carbon footprint associated with natural gas production. Such sustainable approach is essential to mitigate the environmental impacts of the oil and gas industry, being aligned with goals to reduce greenhouse gas emissions and promoting a cleaner and more responsible energy production.

The use of the green ceramic membrane prepared according to the process of the present invention for the separation of CO₂ from natural gas offers a number of important social benefits, from reducing greenhouse gas emissions to promoting economic and technological development, as well as improvements in public health and air quality. These advantages contribute to a more sustainable and resilient future, both socially and environmentally.

1. A process for the preparation of a green multilayer sol-gel ceramic membrane, comprising:
a) producing a tubular shaped porous ceramic support of chemical composition α-Al₂O₃ (1);
b) preparing and depositing the first intermediate ceramic layer of chemical composition α-Al₂O₃ (2);
c) preparing and depositing the second intermediate ceramic layer of chemical composition Γ-AL₂O₃ (3);
d) synthesizing and depositing the ceramic separation sub-layer of the green ceramic membrane, the third mesoporous SiO₂ layer (4); and
e) synthesizing and depositing the ceramic separation sub-layer of the green ceramic membrane, the fourth microporous SiO₂ layer (5).

2. The process according to claim 1, wherein the porous ceramic support is processed via ceramic slurry extrusion followed by heat treatment under room atmosphere and atmospheric pressure.

3. The process, according to claim 2, wherein production of the porous ceramic support comprises the following sub-steps:
a.1) formulating the micrometric α-Al₂O₃ ceramic slurry
a.2) forming the ceramic slurry into a green ceramic body;
a.3) drying the green ceramic body;
a.4) surface finishing the green ceramic body;
a.5) heat treating the green ceramic body;
a.6) cutting and cleaning the ceramic support; and
a.7) completion of the ceramic support.

4. The process, according to claim 2, wherein the porous ceramic support has an average pore size of from 0.7 to 0.9 μm.

5. The process, according to claim 1, wherein the first intermediate ceramic layer is processed via slip deposition of a suspension of submicron α-Al2O3 ceramic particles followed by heat treatment under ambient atmosphere and atmospheric pressure.

6. The process, according to claim 5, wherein the production of the first intermediate ceramic layer comprises the following sub-steps:
b.1) preparing the suspension of submicrometric α-Al2O3 ceramic particles;
b.2) depositing the suspension of α-Al2O3 ceramic particles;
b.3) drying the α-Al2O3 ceramic layer;
b.4) heat treating the α-Al2O3 ceramic layer; and b.5) finishing the α-Al2O3 layer.

7. The process, according to claim 5, wherein the first intermediate ceramic layer has an average pore size of 80 to 100 nm.

8. The process, according to claim 1, wherein the second intermediate ceramic layer is processed via slip deposition of a suspension of nanometric γ-AlOOH ceramic particles synthesized via a sol-gel pathway followed by heat treatment under ambient atmosphere and atmospheric pressure.

9. The process, according to claim 8, wherein production of the second intermediate ceramic layer comprises the following sub-steps:
c.1) synthesizing the suspension of nanometric γ-AlOOH ceramic particles;
c.2) preparing the suspension of γ-AlOOH ceramic particle for deposition;
c.3) depositing the suspension of γ-AlOOH ceramic particles;
c.4) drying the γ-AlOOH layer;
c.5) heat treating the γ-AlOOH layer;
c.6) depositing further γ-AlOOH layers; and
c.7) finishing the γ-Al₂O₃ layer.

10. The process, according to claim 8, wherein the second intermediate ceramic layer has an average pore size of 4 to 20 nm.

11. The process, according to claim 1, wherein the ceramic separation sub-layer of the green ceramic membrane is processed via immersion deposition in a silica polymer chain nanoparticle solution synthesized via the sol-gel pathway followed by heat treatment under ambient atmosphere and atmospheric pressures.

12. The process, according to claim 11, wherein production of the ceramic separation sub-layer comprises the following sub-steps:
a.1) synthesizing the mesoporous silica solution;
d.2) preparing the mesoporous silica solution for deposition;
d.3) depositing the mesoporous silica solution;
d.4) drying the mesoporous silica layer;
d.5) heat treating the mesoporous silica layer;
d.6) depositing further mesoporous silica layers;
d.7) finishing the mesoporous silica layer.

13. The process, according to claim 11, wherein the separation ceramic sub-layer of the green ceramic membrane has an average pore size of 2 nm.

14. The process, according to claim 1, wherein the ceramic separation layer of the green ceramic membrane is processed via immersion deposition in a silica polymer chain solution synthesized via the sol-gel pathway followed by heat treatment under ambient atmosphere and atmospheric pressures.

15. The process, according to claim 14, wherein production of the ceramic separation layer comprises the following sub-steps:
e.1) synthesizing the microporous silica solution;
e.2) preparing the microporous silica solution for deposition;
e.3) depositing the microporous silica solution;
e.4) drying the microporous silica layer;
e.5) heat treating the microporous silica layer;
e.6) depositing further microporous silica layers;
e.7) finishing the fourth microporous silica layer.

16. The process, according to claim 14, wherein the separation ceramic layer of the green ceramic membrane has an average pore size of less than 0.4 nm.
